(19) United States
(12) Patent Application Publication
(10) Pub. No.: US 2011/0091366 A1
(43) Pub. Date: Apr. 21, 2011

(54) NEUTRALIZATION OF ACID AND PRODUCTION OF CARBONATE-CONTAINING COMPOSITIONS

(76) Inventors: Treavor Kendall, Menlo Park, CA (US); Natalie Johnson, Mountain View, CA (US); William Bourcier, Livermore, CA (US); Geoffrey Garrison, Seattle, WA (US); James Bresson, San Jose, CA (US)

(21) Appl. No.: 12/965,022

(22) Filed: Dec. 10, 2010

Related U.S. Application Data
(63) Continuation-in-part of application No. 12/788,255, filed on May 26, 2010.
Application No. 12/788,255 is a continuation-in-part of application No. 12/486,692, filed on Jun. 17, 2009, now Pat. No. 7,754,169.
Application No. 12/486,692 is a continuation-in-part of application No. 12/344,019, filed on Dec. 24, 2008, now Pat. No. 7,887,694.
(60) Provisional application No. 61/305,075, filed on Feb. 16, 2010.
(60) Provisional application No. 61/378,533, filed on Aug. 31, 2010.

(51) Int. Cl. B01D 53/62; C09K 3/00; B01D 50/00

(52) U.S. Cl. 423/220; 252/184; 422/170

(57) ABSTRACT

Provided are methods and systems for neutralizing acidic solution. In such methods, an acidic solution may be generated and methods of raising the pH of the acidic solution are provided that may utilize rocks or mineral. Methods for processing rocks and minerals for digestion by an acidic solution are described. Digestion products of rocks and minerals are provided.

### CROSS-REFERENCE

This application claims the benefit of U.S. Provisional Patent Applications No. 61/305,075, filed on Feb. 16, 2010 and 61/378,533 filed on Aug. 31, 2010. This application is also a continuation-in-part application of U.S. patent application Ser. No. 12/788,255 filed on Jun. 26, 2010, which is a continuation-in-part application of U.S. patent application Ser. No. 12/486,692, filed on Jun. 17, 2009 and U.S. patent application Ser. No. 12/344,019, filed on Dec. 24, 2008, each of which is incorporated herein by reference.

### BACKGROUND

Electrochemical methods to produce alkalinity for the carbon sequestration reaction may produce an acid as a by-product. Improved methods are needed to neutralize or utilize the acid produced to insure that the carbon sequestration method is economical.

### SUMMARY

Provided is a method for an electrochemical reaction to generate a first solution in a first compartment and a second solution in a second compartment of an electrochemical system in which the first solution is alkaline and the second solution is acidic, and in which the acidic solution has a pH that is less than 1.3 or 2. A portion of the first solution may be used to sequester carbon dioxide from a gas comprising carbon dioxide by contacting the gas with a first portion of the first solution. An acid neutralizing material may be digested with the second solution to produce a slurry comprising a third solution, in which the pH of the third solution is higher than pH of the second solution. In some embodiments the digestion product comprises calcium. In some embodiments the pH of the third solution is at least 0.5 pH points greater than the pH of the second solution. In some embodiments the digestion product comprises magnesium and/or silicate. In some embodiments the digestion product is contacted with the sequestered carbon dioxide. In some embodiments the electrochemical reaction is configured to not produce chlorine gas. In some embodiments the digestion product comprises sodium chloride. In some embodiments the acid neutralizing material is a metal silicate such as basalt. In some embodiments the acid neutralizing material is phosphorite.

The invention provides for methods and systems for generating a first solution and a second solution in an electrochemical reaction in which the first solution is alkaline and the second solution is acidic and in which the electrochemical reaction is configured to not produce chlorine gas. The second solution may be used to digest an acid neutralizing material to form a slurry comprising a third solution, in which the pH of the third solution is greater than the pH second solution by at least 0.5 pH units. In some embodiments the electrochemical reaction comprises separating an anode electrolyte in contact with a gas diffusion anode from a cathode electrolyte in contact with a cathode using an ion exchange membrane in an electrochemical system and applying a voltage across the gas diffusion anode and cathode and directing hydrogen gas to the gas diffusion anode using hydrogen gas produced at the cathode and oxidizing hydrogen gas to protons at the anode without producing a gas at the anode and migrating protons from the anode into the anode electrolyte to produce the second solution in the anode electrolyte to avoid the production of a gas.

In some embodiments the first solution may be utilized to sequester carbon dioxide from a gas comprising carbon dioxide by contacting the gas with the first solution. In some embodiments the second solution is between 40 and 84° C. when contacting the acid neutralizing material. In some embodiments the third solution comprises calcium. In some embodiments the second solution comprises an acid selected from hydrochloric acid, sulfuric acid, acetic acid, hydrofluoric acid, boric acid and nitric acid. In some embodiments the second solution is hydrochloric acid. In some embodiments the second solution is between 10 and 36 wt % acid. In some embodiments the pH of second solution is between −1 and 1. In some embodiments the acid neutralizing material is less than 1 wt % carbonate. In some embodiments the acid neutralizing material is a metal silicate. In some embodiments the acid neutralizing material is phorsphorite. In some embodiments a divalent cation released from the acid neutralizing material may be contacted with the sequestered carbon dioxide to precipitate a carbonate containing compound. In some embodiments the acid neutralizing material comprises silicates or phosphorus that may be released into the third solution. In some embodiments phosphoric acid may be generated by the contact of the acidic solution generated by the electrochemical reaction and the acid neutralizing material. In some embodiments the sequestered carbon dioxide and the silicates may be combined to produce a building material. In some embodiments the acid neutralizing material comprises mafic rock such as basalt. In some embodiments the acid neutralizing material may be ultramafic rock such as serpentine. In some embodiments the acid neutralizing material comprises felsic rock such as granite.

In some embodiments the methods and systems of this invention provide for the neutralization of an acidic solution from an electrochemical reaction with an acid neutralizing material that is anorthite and in which contacting anorthite and the acidic solution forms kaolinite and a divalent cation. In some embodiments the method provides for storing the kaolinite underground. In some embodiments the method provides for using the kaolinite is in an industrial process for example converting the kaolinite to metakaolin. In some embodiments the divalent cation and the metakaolin may be contacted with the sequestered carbon dioxide to form a building material. In some embodiments digesting the acid neutralizing material occurs below ground. In some embodiments digesting the acid neutralizing material occurs above ground. In some embodiments the third acidic solution may be contacted with a second portion of the first solution to form a neutral solution. The neutralized solution may comprise NaCl at a concentration of between 20 and 90 wt %. In some embodiments the neutralized solution may be transported to an underground location. In some embodiments a portion of the neutralized solution may be used in the electrochemical reaction. In some embodiments the average particle size of the acid neutralizing material is between 50 and 200 μm. In some embodiments the method may further comprise reducing the average particle size of the acid neutralizing material to less than 50 μm by ultrasonic milling, such as cavitation. In some embodiments the acid neutralizing material comprises one or more transition metals. In some embodiments the transition metals are recovered from the third solution after digestion of the acid neutralizing material by the second solution. In some embodiments the metals are Cu, Au, Zn, Cd, Ag, or Mn. In some embodiments the acid neutralizing material comprises an industrial waste. In some embodiments the industrial waste may comprise fly ash, mine tailings, slag, or cement kiln waste. In some embodiments the electrochemical reaction operates at voltage of less than 2 volts. In some embodiments the electrochemical reaction is configured to avoid production of chlorine gas. In some embodiments the method further comprises contacting the third solution with a second portion of the acid neutralizing material to form a forth solution wherein the pH of the forth solution is higher than the third solution.

Systems provided by this invention may include an electrochemical system suitable for generating an first solution in a first compartment and a second solution in a second compartment, and in which the second compartment is suitable for containing a solution that has a pH that is less than 1.3. The system may also include a first reaction vessel operably connected to a source of waste gas and the first compartment of the electrochemical system. The reaction vessel may be an absorber suitable for contacting a gas comprising carbon dioxide with the first solution to sequester carbon dioxide. A second reaction vessel may be operably connected to the second compartment of the electrochemical system and a source of an acid neutralizing material suitable to contact the second solution comprising a pH of less that 1.3 with the acid neutralizing material in which the contact is sufficient to form a third solution that has a higher pH than the second solution. In some embodiments sufficient contact may be promoted by mixers or agitators or the like. In some embodiments the acid neutralizing material comprises a divalent cation and the reaction vessel is suitable for promoting the release of the divalent cation into the third solution and further comprises a third reaction vessel operably connected to the first reaction vessel and the second reaction vessel suitable for contacting the third solution to the sequestered carbon dioxide in which the contact is sufficient to generate a carbonate precipitate material.

Systems of this invention may include an electrochemical system suitable for producing a first solution in a first compartment and second solution in a second compartment operably connected to a carbon dioxide contact system comprising an absorber wherein the first solution is contacted with a gas comprising carbon dioxide wherein the absorber is operably connected to the first compartment and a reaction vessel operably connected to the second compartment wherein the reaction vessel is suitable for contacting a neutralizing material comprising a metal silicate with the second solution sufficient for generating a third solution wherein the third solution has a higher pH than the second solution and wherein the reaction vessel is suitable for containing a solution with a pH less than 1.3. In some embodiments the electrochemical system is configured to prevent the release of chlorine gas. In some embodiments system is configured to the produce the acidic solution composition at a voltage of 2.0 volts or less. In some embodiments the acid neutralizing material comprises an alkaline earth metal which is released into the solution. In some embodiments the CO₂ sequestration system is operably connected to the reaction vessel.

Methods of this invention may provide for generating an alkaline solution and an acidic solution in an electrochemical reaction, wherein the acidic solution has a pH that is less than 2 and contacting a gas comprising carbon dioxide with the alkaline solution under conditions sufficient to sequester the carbon dioxide in an aqueous solution and introducing the acidic solution into a subterranean formation comprising an acid neutralizing mineral. In some embodiments the acidic solution has a pH less than 1. In some embodiments the subterranean formation is 500 meters or more below ground level. In some embodiments the pH of the acidic solution is raised upon contact with the acid neutralizing mineral. In some embodiment the subterranean location is an aquifer. In some embodiments the acidic solution releases divalent cations into the aquifer. In some embodiments the divalent cations are used to form a precipitation material. In some embodiments the acid solution is electrochemically produced by an electrochemical protocol that employs a voltage of 2.0 V or less. In some embodiments the method further comprises processing the acidic solution composition prior to introducing the acidic solution into the subterranean formation. In some embodiments processing comprises contacting the acidic solution with an acid neutralizing material. In some embodiments the subterranean formation comprises sandstone. In some embodiments the method further comprises producing a bore hole into the subterranean formation. In some embodiments the method further comprises inserting one or more conduits that are operably connected to a source of the acidic solution into the bore hole.

### DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a schematic representation of an electrochemical method of this invention.

FIG. 2 shows a flowchart representation of an exemplary method for producing and acidic solution and an alkaline solution and generating a more neutral solution from the acidic solution.

FIG. 3 shows a flowchart representation of methods for neutralizing an acidic solution of this invention.

FIG. 4 shows a flowchart representation of methods for utilizing the digestion products acidic solution and acid neutralizing material of this invention.

FIG. 5 shows a schematic representation of a system for neutralizing an acidic solution according to an embodiment of the invention.

FIGS. 6A and B show a schematic representation of a system for neutralizing an acidic solution according to an embodiment of the invention.

FIGS. 7A through C show the results of neutralization experiments with mafic and ultramafic rocks.

FIG. 8 shows a flowchart representation of phosphoric acid manufacture linked to a carbon sequestration system.

### DESCRIPTION

Methods and systems are disclosed for the neutralization of an acid. In some embodiments the methods and systems disclosed provide for the generation of an acidic and an alkaline solution (e.g., in two separate compartments) from an electrochemical reaction. In some embodiments a portion of the alkaline solution may be used to sequester carbon dioxide 140 from a gas. The acidic solution (e.g., pH less than 7) may be used to digest an acid neutralizing material such as a metal silicate or a phosphate in order to raise the pH of the solution. In some embodiments the acid neutralizing material may not release carbon dioxide into the atmosphere during the acid neutralizing process. In some embodiments the products of a digestion reaction with a metal silicate or phosphorite may be useful in the carbon dioxide sequestration process.

Before the invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are now described.

All publications, patents, and patent applications mentioned in this specification are incorporated herein by reference to the same extent as if each individual publication, patent, or patent application was specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

Materials used to produce compositions of the invention are described first in a section with particular attention to sources of CO₂, divalent cations, and proton-removing agents (and methods of effecting proton removal). A description of material comprising metal silicates and/or related materials that may be used in the invention (e.g. as acid neutralizing materials) is also provided in the section on materials. Methods for neutralizing acidic solutions generated as part of the carbon sequestration process are provided. Methods by which materials (e.g., CO₂, divalent cations, etc.) may be incorporated into compositions of the invention are described next. Methods of neutralization of the acid by-product of a carbon sequestration process are provided. Subsequently, systems of the invention are described followed by description of compositions of the invention, products comprising those compositions, and used thereof. Subject matter is organized as a convenience to the reader and in no way limits the scope of the invention. For example, should a particular material comprising metal silicates be disclosed or described in a section (e.g., the section on methods) other than the section on material comprising metal silicates, it should be understood that the particular material comprising metal silicates is part of the material comprising metal silicates disclosure. Continuing with the same example, it should be understood that the section on material comprising metal silicates is not exhaustive and that additional material comprising metal silicates may be used in the invention without departing from the spirit and scope of the invention.

Sequestration of Carbon Dioxide

As described in commonly assigned U.S. patent application Ser. No. 12/344,019 supra, herein incorporated by reference in its entirety, carbon dioxide may be sequestered by dissolving the gas in an aqueous solution Eq. I to produce aqueous carbon dioxide. This may be converted to carbonic acid, which will dissociate into bicarbonate ions and carbonate ions in accordance with Eq. II, depending on the pH of the solution when hydroxide ions are added to the solution Eq. III. The conversion of carbonic acid into bicarbonate and carbonate may be accomplished through the addition of a proton-removing agent (e.g., a base) (III-IV). Chemically, aqueous dissolution of CO₂ may be described by the following set of equations:

CO₂(g)⇄CO₂(aq)(in the presence of water) (I)

CO₂(aq)+H₂O⇄H₂CO₃(aq) (II)

Conversion to bicarbonate may described by the following equations:

H₂CO₃(aq)+OH⁻(aq)⇄HCO₃⁻(aq)+H₂O (III)

CO₂(aq)+OH⁻(aq)⇄HCO₃⁻(aq) (IV)

In the methods described herein, at least some of the captured carbon dioxide may be converted to bicarbonate or carbonate ions through the addition of proton-removing agents.

As described in detail below, contacting the alkaline solution with a source of CO₂ may employ any suitable protocol, such as for example by employing gas bubblers, contact infusers, fluidic Venturi reactors, spargers, components for mechanical agitation, stirrers, components for recirculation of the source of CO₂ through the contacting reactor, gas filters, sprays, trays, or packed column reactors, and the like, as may be convenient.

Aspects of the invention also include methods for contacting a solution with carbon dioxide to produce a carbon containing reaction product (e.g., an aqueous solution comprising carbonic acid, bicarbonate, carbonate or combination thereof). The reaction product may be a clear liquid. In some embodiments of methods of this invention, the gaseous reagent comprises CO₂ levels greater than those found in the atmosphere. A gas comprising CO₂ at levels greater than those found in the atmosphere may be contacted with an aqueous mixture. The aqueous mixture may be an alkaline solution. In certain embodiments of the invention, a portion of reaction product produced by contacting carbon dioxide with an alkaline solution may be further placed in a location (e.g., in a in a subterranean site), effectively sequestering carbon dioxide in the form of any combination of a carbonic acid, bicarbonate and carbonate mixture. Alternatively, or in addition to sequestering the reaction product, the carbonic acid, bicarbonate, carbonate, carbonate composition may further be contacted with a source of one or more proton-removing agents and/or a source of one or more divalent cations to produce a precipitated material comprising carbonates and/or bicarbonates. A portion of the precipitated material may be placed in a subterranean site or used as a commercial product (e.g., a building material). In some embodiments sequestering the reaction product may comprise placing the reaction product in a subterranean location.

“Alkaline solution” as used herein includes an aqueous composition which possesses sufficient alkalinity or basicity to remove one or more protons from proton-containing species in solution. Proton removing agents are discussed in greater detail below. The stoichiometric sum of proton-removing agents in the alkaline solution exceeds the stoichiometric sum of proton-containing agents expressed as equivalents or milliequivalents (mEq.). In some instances, the alkaline solution has a pH that is above neutral pH (i.e., pH>7), e.g., the solution has a pH ranging from 7.1 to 12, such as 8 to 12, such as 8 to 11, and including 9 to 11. For example, the pH of the alkaline solution may be 9.5 or higher, such as 9.7 or higher, including 10 or higher.

Adding hydroxide ions, for example, to a solution in the form of sodium hydroxide will promote the dissociation of dissolved carbonic acid into its ionic species will shift to the right; alternatively by adding protons to the solution an acid e.g., hydrochloric to the solution the speciation to the left. Thus, by regulating the pH of the solution, e.g., by adding sodium hydroxide to the solution, the carbon dioxide gas will be converted to a bicarbonate or bicarbonate, in accordance with Eq. III-IV thereby sequestering the gas since sodium carbonate or bicarbonate produced can be stored indefinitely is a stable-storage from.

As can be appreciated, other stable-storage carbonates and bicarbonate may be produced, including calcium and/or magnesium carbonate and/or bicarbonate, by adding the appropriate salt solution to replace the alkaline earth metals and preferentially precipitate the insoluble alkaline earth metal carbonate and/or bicarbonate over the more soluble alkaline metal carbonates and bicarbonates, as described in commonly assigned U.S. Pat. No. 7,735,274 supra hereby incorporated by reference in its entirety.

Materials

As described in further detail below, the invention involves the use of one or more of a source of CO₂, a source of alkalinity, a source of acidity, and an acid neutralizing agent. Material with acid neutralizing properties (e.g., mafic, ultramafic, or felsic minerals or sedimentary rock, and materials further described below) and/or related materials may provide, in whole or in part (in addition to their acid neutralizing capacity), a source of divalent cations that may be combined with sequestered carbon dioxide to form a precipitate. In some embodiments material comprising acid neutralizing capacity may be the sole source of divalent cations for preparation of the compositions described herein. Acid neutralizing material may comprise silicates and/or related materials that may also be used in combination with sources of divalent cations for preparation of compositions described herein. Carbon dioxide sources, supplemental divalent cation sources, and alkaline solutions (and methods of effecting proton removal), will first be described. Material comprising metal silicates (e.g., mafic, ultramafic, felsic rocks, etc.) will be described, followed by methods in which acid neutralizing material comprising silicates and/or divalent cations may be used to produce compositions comprising carbonates, compositions comprising silica, or combinations thereof.

Carbon Dioxide

In some embodiments, methods of the invention include contacting a solution with a source of CO₂ to form a composition comprising water, carbonic acids, dissolved carbon dioxide, bicarbonates, or carbonates, or any combination thereof, in which the composition is a solution, slurry, or solid material. In some embodiments, the resultant composition is subjected to conditions that induce precipitation of a precipitation material. The source of CO₂ may be any suitable source in any suitable form including, but not limited to, a gas, a liquid, a solid (e.g., dry ice), a supercritical fluid, and CO₂ dissolved in a liquid. In some embodiments, the CO₂ source is a gaseous CO₂ source. The gaseous stream may be substantially pure CO₂ or comprise multiple components that include CO₂ and one or more additional gases and/or other substances such as ash and other particulate material. In some embodiments, the gaseous CO₂ source is a waste feed (i.e., a by-product of an active process of the industrial plant) such as exhaust from an industrial plant. The nature of the industrial plant may vary, the industrial plants of interest including, but not limited to, power plants, chemical processing plants, mechanical processing plants, refineries, cement plants, smelters, steel plants, and other industrial plants that produce CO₂ as a by-product of fuel combustion or another processing step (such as calcination by a cement plant).

Waste gas streams comprising CO₂ include both reducing (e.g., syngas, shifted syngas, natural gas, hydrogen and the like) and oxidizing condition streams (e.g., flue gases from combustion). Particular waste gas streams that may be convenient for the invention include oxygen-containing combustion industrial plant flue gas (e.g., from coal or another carbon-based fuel with little or no pretreatment of the flue gas), turbo charged boiler product gas, coal gasification product gas, shifted coal gasification product gas, anaerobic digester product gas, wellhead natural gas stream, reformed natural gas or methane hydrates, and the like. Combustion gas from any convenient source may be used in methods and systems of the invention. In some embodiments, combustion gases in post-combustion effluent stacks of industrial plants such as power plants, cement plants, smelters, and coal processing plants is used.

Thus, the waste streams may be produced from a variety of different types of industrial plants. Suitable waste streams for the invention include waste streams produced by industrial plants that combust fossil fuels (e.g., coal, oil, natural gas) or anthropogenic fuel products of naturally occurring organic fuel deposits (e.g., tar sands, heavy oil, oil shale, etc.). In some embodiments, a waste stream suitable for systems and methods of the invention is sourced from a coal-fired power plant, such as a pulverized coal power plant, a supercritical coal power plant, a mass burn coal power plant, a fluidized bed coal power plant. In some embodiments, the waste stream is sourced from gas or oil-fired boiler and steam turbine power plants, gas or oil-fired boiler simple cycle gas turbine power plants, or gas or oil-fired boiler combined cycle gas turbine power plants. In some embodiments, waste streams produced by power plants that combust syngas (i.e., gas that is produced by the gasification of organic matter, for example, coal, biomass, etc.) are used. In some embodiments, waste streams from integrated gasification combined cycle (IGCC) plants are used. In some embodiments, waste streams produced by Heat Recovery Steam Generator (HRSG) plants are used to produce compositions in accordance with systems and methods of the invention.

Waste streams produced by cement plants are also suitable for systems and methods of the invention. Cement plant waste streams include waste streams from both wet process and dry process plants, which plants may employ shaft kilns or rotary kilns, and may include pre-calciners. These industrial plants may each burn a single fuel, or may burn two or more fuels sequentially or simultaneously.

While industrial waste gas streams suitable for use in the invention contain carbon dioxide, such waste streams may, especially in the case of power plants that combust carbon-based fuels (e.g., coal), contain additional components such as water (e.g., water vapor), CO, NOₓ (mononitrogen oxides: NO and NO₂), SO_{X} (monosulfur oxides: SO, SO₂ and SO₃), VOC (volatile organic compounds), heavy metals and heavy metal-containing compounds (e.g., mercury and mercury-containing compounds), and suspended solid or liquid particles (or both). Additional components in the gas stream may also include halides such as hydrogen chloride and hydrogen fluoride; particulate matter such as fly ash, dusts (e.g., from calcining), and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and polycyclic aromatic hydrocarbon (PAH) compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. Flue gas temperature may also vary. In some embodiments, the temperature of the flue gas is from 0° C. to 2000° C., such as from 60° C. to 700° C., and including 100° C. to 400° C.

Alkaline and Acidic Solutions

In some embodiments methods of the invention include contacting a volume of a solution with a source of CO₂ to form an composition including carbonic acid, bicarbonate, carbonate, dissolved carbon dioxide or any combination thereof, wherein the composition may be a solution, or a slurry. In some embodiments the solution in which the carbon dioxide contacted may be alkaline. In some embodiments, the resultant composition is prepared for injection into a subterranean location. In some embodiments, the resultant product mixture is subjected to conditions that induce precipitation of a precipitation material. Protons may be removed from various species (e.g., carbonic acid, bicarbonate, hydronium, etc.) in the solution to shift the equilibrium toward bicarbonate or carbonate. As protons are removed, more CO₂ goes into solution. In some embodiments, proton-removing agents and/or methods are used while contacting a cation-containing aqueous solution with CO₂ to increase CO₂ absorption in one phase of the reaction, where the pH may remain constant, increase, or even decrease. Protons may be removed from the various species (e.g., carbonic acid, bicarbonate, hydronium, etc.) by any convenient approach, including, but not limited use of waste sources of metal oxides such as combustion ash (e.g., fly ash, bottom ash, boiler slag), cement kiln dust, and slag (e.g., iron slag, phosphorous slag), use of naturally occurring proton-removing agents, use of microorganisms and fungi, use of synthetic chemical proton-removing agents, recovery of man-made waste streams, alkaline brines, electrochemical means, and combinations thereof.

Electrochemical methods are another means to remove protons from various species in a solution. Electrochemical methods may be used to produce caustic molecules (e.g., hydroxide) through, for example, the chlor-alkali process, or modifications thereof. In some embodiments electrochemical systems and methods for removing protons may produce an acidic solution in a separate compartment that may be harvested and used for other purposes. In some embodiments some or all of the acid may be contacted with an acid neutralizing material. The acidic solution may be treated to raise the pH of the solution so that it is suitable for disposal. The acidic solution may used to digest an acid neutralizing material to generate a useful material (such as divalent cations, phosphoric acid, silicates etc. . . . ). The material generated by the digestion of an acid neutralizing material may be used to precipitate sequestered carbon dioxide. Additional electrochemical approaches that may be used in systems and methods of the invention include, but are not limited to, those described in U.S. patent application Ser. No. 12/344,019, filed 24 Dec. 2008; U.S. patent application Ser. No. 12/375,632, filed 23 Dec. 2008, International Patent Application No. PCT/US08/088,242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Combinations of any of the above mentioned sources of proton-removing agents and methods for effecting proton removal may also be employed.

Herein, exemplary systems and methods are disclosed wherein a salt solution (e.g., sodium chloride or sodium sulfate solution) may be used in one compartment between the anode electrolyte and cathode electrolyte to produce an alkaline solution (e.g., sodium hydroxide) in the cathode electrolyte, and an acidic solution (e.g., hydrochloric acid, or sulfuric acid, etc. . . . ) with a pH that is less than 7 in the anode electrolyte. In some embodiments the pH of the acidic solution produced may be less than 4, or 3, or 2, or 1.3 or 1.0. In some embodiments the pH of the acidic solution produced may be less than 0.5. As will be appreciated by one ordinarily skilled in the art, the system and method are not limited to the use of sodium chloride solution as disclosed in these exemplary embodiments since the system and method are capable of using an equivalent salt solution, e.g., an aqueous solution of sodium sulfate or other appropriate salt and the like to produce an equivalent result. In preparing the electrolytes for the system, it will be appreciated that water from various sources can be used including seawater, brackish water, brines or naturally occurring fresh water, provided that the water is purified to an acceptable level for use in the system. Therefore, to the extent that such equivalents embody the present system and method, these equivalents are within the scope of the appended claims. In some embodiments the acidic solution produced by the electrochemical system may be hydrochloric acid, sulfuric acid, hydrofluoric acid, boric acid, nitric acid etc. In some embodiments the acidic solution produced in the anolyte may be between 3 and 30 wt % acid. In some embodiments the acidic solution produced in the anolyte may be at least 3 wt %, 4 wt %, or 5 wt % acid. In some embodiments the acidic solution produced in the anolyte may be between 5 and 10 wt %, between 10 and 20 wt %, between 20 and 30 wt % or between 30 and 36% wt % acid. In some embodiments the pH may be less than 1. In some embodiments the pH may be less than 0.5. The electrochemical system may generate thermal energy that may be transferred to the acidic solution. In some embodiments the acidic solution may be between 40 and 100° C. (e.g., between 40 and 50° C. or between 40 and 60° C. or between 40 and 84° C.). In some embodiments the temperature of acidic solution may change less than 10° C. when it contacts the acid neutralizing material.

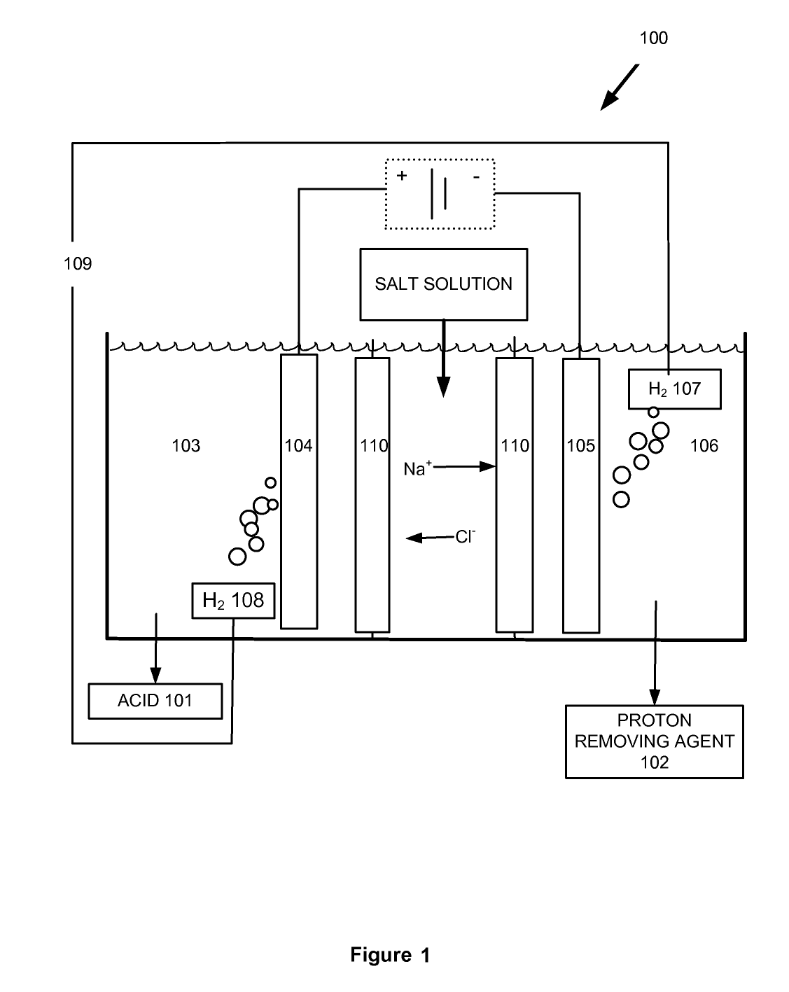

In some embodiments alkaline hydroxides may be produced electrochemically from an aqueous salt solution. An embodiment of a system is described with reference to FIG. 1 herein, a proton removing agent 102 (e.g., sodium hydroxide) is produced by an electrochemical system 100 wherein in one embodiment at the cathode 105, water is reduced to a proton removing agent 102 and hydrogen gas 107 that migrates into the catholyte 106; and at the anode 104, hydrogen gas 108 is oxidized to acid 101 that migrates into the anolyte 103. In some systems, by using ion exchange membranes 110 to separate the anolyte, catholyte and salt solution, and by applying a voltage across the anode 104 and cathode 105 an alkaline solution i.e., sodium hydroxide, is produced in the catholyte and an acid i.e., hydrochloric acid, is produced in the anolyte or in an electrolyte separated from the anolyte by a cation exchange membrane. In some embodiments carbon dioxide is added to the catholyte to lower the cell voltage across the anode and cathode, and also to produce sodium bicarbonate and or sodium carbonate solution with the catholyte. The carbon dioxide may be added in a compartment separate from the cathode compartment when the compartments are operably connected

In some embodiments, an aqueous salt solution, e.g., sodium chloride or sodium sulfate solution is electrolyzed to produce the alkaline solution comprising hydroxide ions in the catholyte in contact with the cathode, and hydrogen gas at the cathode, while minimizing or eliminating the production of chlorine gas. Concurrently, protons produced by the oxidation at the anode migrate into the anolyte in contact with the anode to produce an acid, e.g., hydrochloric acid or sulfuric acid with cations from the salt solution. The system and method may be configured to operate at a voltage of 2.0 volts or less (e.g., 1.8 volts or less) applied across the anode and the cathode. Industrial amounts of an alkaline solution may be produced in electrochemical systems based on the chlor-alkali process or in a process that do not involve the generation of chlorine. Methods and systems used in sequestering carbon dioxide include sodium hydroxide produced in an electrochemical process e.g., from a sodium chloride solution or sodium sulfate. In one embodiment of the electrochemical process, as described in commonly assigned U.S. Pat. No. 7,790,012 herein incorporated by reference, sodium hydroxide is produced in the cathode compartment and migration of sodium ions from the salt solution into the cathode compartment to produce sodium hydroxide in the catholyte in contact with the cathode as shown in equation V.

2H₂O+2e⁻→H₂+2OH⁻ (Eq. V)

In some embodiments the co-product hydrogen gas produced at the cathode may be recovered and used at the anode 209 as described below. In the anode compartment, depending on which oxidation reaction occurs at the anode, either chlorine gas or hydrochloric acid may be produced based on equations VI and VII.

2Cl⁻→Cl₂+2e− (Eq. VI)

H₂→2H⁺+2e− (Eq. VII)

Where chlorine gas is produced as in Eq. VI, the gas can be recovered and used elsewhere; and where hydrogen is oxidized at the anode as in Eq. VII, the hydrogen gas produced at the cathode as in Eq. VI may be used at the anode. Alternatively, hydrogen from an exogenous source may be used. In some embodiments hydrogen is oxidized to protons at the anode under the applied overall cell voltage, the protons migrate into the anolyte in contact with the anode and combine with chloride ions to produce hydrochloric acid. As used herein, the anolyte is the electrolyte in contact with the anode, and the catholyte is the electrolyte in contact with the cathode; thus the anolyte may migrate or supply anions to or from the anode and similarly the catholyte can migrate or supply ions to or from the cathode.

As can be appreciated, in producing an alkaline solution as described above, the cost of the production is largely determined by the overall cell voltage across the anode and cathode in the system. As used herein the overall cell voltage is the voltage required to achieve the redox reactions at the anode and cathode and to overcome ohmic resistance in the system to produce the products in the catholyte and anolyte. Thus, the overall cell voltage includes the half-cell redox reactions voltages at the electrodes and the voltage drops in the system due to ohmic resistances, the desired current density at the cathode, the temperature, pH and concentration of the electrolytes, the size of the inter-electrode gap, the presence of ion exchange membranes, diaphragms and other ionic barriers interposed between the electrodes to control the migration of ions in the system, and other design and operating parameters in the system.

One means by which the overall cell voltage may be reduced is not to produce a gas (e.g., chlorine, oxygen) at the anode, but rather to oxidize hydrogen at the anode to yield an acid. The methods of this invention provide for utilizing acid produced by an electrochemical process described here to advantageously further increase the economic efficiency of the process. In some embodiments, the hydrogen produced at the cathode may circulated to the anode to reduce the need for an external supply of hydrogen gas and hence reduce the overall energy utilized in the system to produce the alkaline solution.

In some embodiments, the sodium hydroxide is produced in the cathode electrolyte. When a voltage of less than 2 or less than 1.5, 1.4, 1.3, 1.2, 1.1, or 1.0 volts is applied across the cathode and anode. Concurrently, the hydrogen provided to the anode is oxidized to protons that migrate in the anolyte to produce an acid, e.g., hydrochloric acid or sulfuric acid in the anolyte. In methods of this invention utilization methods are described that may provide for increased economic efficiency of the electrochemical reaction.

In another embodiment, the present hydrogen anode assembly is described in greater detail in U.S. Pat. No. 5,595,641, titled: “Apparatus and Process for Electrochemically Decomposing Salt Solutions to form the Relevant Base and Acid”, herein incorporated by reference. In some embodiments, an electrolyzer comprising at least one elementary cell divided into electrolyte compartments by cation-exchange membranes, wherein said compartments are provided with a circuit for feeding electrolytic solutions and a circuit for withdrawing electrolysis products, and wherein said cell is equipped with a cathode and a hydrogen-depolarized anode assembly forming a hydrogen gas chamber fed with a hydrogen-containing gaseous stream, characterized in that said assembly comprises a cation-exchange membrane, a porous, flexible electrocatalytic sheet, a porous rigid current collector having a multiplicity of contact points with said electrocatalytic sheet, said membrane, sheet and current collector are held in contact together by means of pressure without bonding.

In some embodiments the electrochemical reaction may include interposing an ion exchange membrane between an anode compartment comprising a gas diffusion anode and a cathode compartment comprising a catholyte in contact with a cathode in an electrochemical system. Another embodiment of the present hydrogen anode membrane assembly is provided in U.S. Pat. No. 5,985,197, titled: “Catalysts For Gas Diffusion Electrodes”, herein incorporated by reference.

Divalent Cations

Methods of the invention include contacting a volume of an aqueous solution of divalent cations with a source of sequestered carbon dioxide (e.g., carbonic acid, bicarbonate, and/or carbonate) and subjecting the resultant solution to precipitation conditions. In addition to divalent cations sourced from acid neutralizing material, divalent cations may come from any of a number of different divalent cation sources depending upon availability at a particular location. As disclosed above, divalent cations released from acid neutralizing material (e.g., mafic, ultramafic, felsic rocks and/or minerals) in a digestion reaction with an acidic solution derived from an electrochemical reaction and described in detail in a respective section below, may be the sole source of divalent cations for preparation of the compositions described herein. Material comprising divalent cations may also be used in combination with supplemental sources of divalent cations as described in this section. Such sources include industrial wastes, seawater, subterranean brines, hard waters, minerals (e.g., lime, periclase), and any other suitable source.

In some locations, industrial waste streams from various industrial processes provide for convenient sources of divalent cations (as well as in some cases other materials useful in the process, e.g., metal hydroxide). Such waste streams include, but are not limited to, mining wastes; fossil fuel burning ash (e.g., combustion ash such as fly ash, bottom ash, and boiler slag); slag (e.g., iron slag, phosphorous slag); cement kiln waste; oil refinery/petrochemical refinery waste (e.g., Oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge. Fossil fuel burning ash, cement kiln dust, and slag, collectively waste sources of metal oxides, further described in U.S. patent application Ser. No. 12/486,692, filed 17 Jun. 2009, the disclosure of which is incorporated herein in its entirety, may be used in combination with material comprising metal silicates to provide, for example, divalent cations for the invention.

In some locations, a convenient source of divalent cations for use in systems and methods of the invention is water (e.g., an aqueous solution comprising divalent cations such as seawater or surface brine), which may vary depending upon the particular location at which the invention is practiced. Suitable aqueous solutions of divalent cations that may be used include solutions comprising one or more divalent cations, e.g., alkaline earth metal cations such as Ca²⁺ and Mg²⁺. In some embodiments, the aqueous source of divalent cations comprises alkaline earth metal cations. In some embodiments, the alkaline earth metal cations include calcium, magnesium, or a mixture thereof. In some embodiments, the aqueous solution of divalent cations comprises calcium in amounts ranging from 50 to 50,000 ppm, 50 to 40,000 ppm, 50 to 20,000 ppm, 100 to 10,000 ppm, 200 to 5000 ppm, or 400 to 1000 ppm. In some embodiments, the aqueous solution of divalent cations comprises magnesium in amounts ranging from 50 to 40,000 ppm, 50 to 20,000 ppm, 100 to 10,000 ppm, 200 to 10,000 ppm, 500 to 5000 ppm, or 500 to 2500 ppm. In some embodiments, where Ca²⁺ and Mg²⁺ are both present, the ratio of Ca²⁺ to Mg²⁺ (i.e., Ca²⁺:Mg²⁺) in the aqueous solution of divalent cations is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Ca²⁺ to Mg²⁺ in the aqueous solution of divalent cations is between 1:1 and 1:10; 1:5 and 1:25; 1:10 and 1:50; 1:25 and 1:100; 1:50 and 1:500; or 1:100 and 1:1000. In some embodiments, the ratio of Mg²⁺ to Ca²⁺ (i.e., Mg²⁺:Ca²⁺) in the aqueous solution of divalent cations is between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, in some embodiments, the ratio of Mg²⁺ to Ca²⁺ in the aqueous solution of divalent cations is between 1:1 and 1:10; 1:5 and 1:25; 1:10 and 1:50; 1:25 and 1:100; 1:50 and 1:500; or 1:100 and 1:1000.

The aqueous solution of divalent cations may comprise divalent cations derived from freshwater, brackish water, seawater, or brine (e.g., naturally occurring brines or anthropogenic brines such as geothermal plant wastewaters, desalination plant waste waters, produced water from petroleum mining), as well as other saline waters having a salinity that is greater than that of freshwater, any of which may be naturally occurring or anthropogenic. Brackish water is water that is saltier than freshwater, but not as salty as seawater. Brackish water has a salinity ranging from about 0.5 to about 35 ppt (parts per thousand). Seawater is water from a sea, an ocean, or any other saline body of water that has a salinity ranging from about 35 to about 50 ppt. Brine may have a salinity that is about 50 ppt or greater. In some embodiments, the water source from which divalent cations are derived is a mineral rich (e.g., calcium-rich and/or magnesium-rich) freshwater source. In some embodiments, the water source from which divalent cations are derived is a naturally occurring saltwater source selected from a sea, an ocean, a lake, a swamp, an estuary, a lagoon, a surface brine, a deep brine, an alkaline lake, an inland sea, or the like. In some embodiments, the water source from which divalent cations are derived is anthropogenic brine selected from a geothermal plant wastewater or a desalination wastewater.

Freshwater is often a convenient source of divalent cations (e.g., cations of alkaline earth metals such as Ca²⁺ and Mg²⁺). Any of a number of suitable freshwater sources may be used, including freshwater sources ranging from sources relatively free of minerals to sources relatively rich in minerals. Mineral-rich freshwater sources may be naturally occurring, including any of a number of hard water sources, lakes, or inland seas. Some mineral-rich freshwater sources such as alkaline lakes or inland seas (e.g., Lake Van in Turkey) also provide a source of pH-modifying agents. Mineral-rich freshwater sources may also be anthropogenic. For example, a mineral-poor (soft) water may be contacted with a source of divalent cations such as alkaline earth metal cations (e.g., Ca²⁺, Mg²⁺, etc.) to produce a mineral-rich water that is suitable for methods and systems described herein. Divalent cations or precursors thereof (e.g., salts, minerals) may be added to freshwater (or any other type of water described herein) using any convenient protocol (e.g., addition of solids, suspensions, or solutions). In some embodiments, divalent cations selected from Ca²⁺ and Mg²⁺ are added to freshwater. In some embodiments, monovalent cations selected from Na⁺ and K⁺ are added to freshwater. In some embodiments, freshwater comprising Ca²⁺ is combined with combustion ash (e.g., fly ash, bottom ash, boiler slag), or products or processed forms thereof, yielding a solution comprising calcium and magnesium cations.

In some embodiments, an aqueous solution of divalent cations may be obtained from an industrial plant that is also providing a combustion gas stream. For example, in water-cooled industrial plants, such as seawater-cooled industrial plants, water that has been used by an industrial plant for cooling may then be used as water for producing precipitation material. If desired, the water may be cooled prior to entering the precipitation system. Such approaches may be employed, for example, with once-through cooling systems. For example, a city or agricultural water supply may be employed as a once-through cooling system for an industrial plant. Water from the industrial plant may then be employed for producing precipitation material, wherein output water has a reduced hardness and greater purity. If desired, such systems may be modified to include security measures (e.g., to detect tampering such as addition of poisons) and coordinated with governmental agencies (e.g., Homeland Security or other agencies). Additional tampering or attack safeguards may be employed in such embodiments.

Acid Neutralizing Agents

As disclosed above, and in further detail below, in some embodiments, the invention utilizes one or more of a source of CO₂, a source of alkalinity (and/or methods of effecting proton removal), a source of acidity, a source of divalent cations and an acid neutralizing material. In some embodiments the acid neutralizing material may comprise metal silicates (e.g., metal silicates such as mafic and ultramafic rock comprising metal silicates). In some embodiments the acid neutralizing material may be a phosphate containing mineral, such as apatite (Ca₃(PO₄)₂). The acid neutralizing material may provide a source of divalent cations (e.g., Ca²⁺, Mg²⁺), a source of proton-removing agents (e.g., metal oxides such as CaO and MgO; metal hydroxides such as Ca(OH)₂ and Mg(OH)₂), rare earth elements, transition metals etc., in addition to raising the pH of an acidic solution (e.g., by greater than 0.5, 1.0 or 2.0 pH units). Furthermore, material comprising metal silicates may provide silica content to compositions of the invention. In some embodiments, material comprising metal silicates provides the sole source of divalent cations for preparation of the compositions described herein. In some embodiments, material comprising metal silicates is used in combination with supplemental sources of divalent cations. Likewise, in some embodiments, material comprising metal silicates provides the sole source of proton-removing agents or divalent cations for preparation of the compositions described herein. In some embodiments, material comprising metal silicates is used in combination with supplemental sources of proton removing agents. In some embodiments, material comprising metal silicates provides the sole source of divalent cations for preparation of the composition described herein and in addition to providing neutralization for an acidic solution.

In some embodiments the acid neutralizing material may be any rock or mineral that may raise the pH of an acidic solution when the acidic solution is contacted with the rock or mineral. In some embodiments basalt, granite, and/or cinder quarries may be a source of an acid neutralizing material. In some embodiments the acid neutralizing material may the byproduct of mining or quarrying rocks and minerals such as fine grains from a basalt quarry. In some embodiments the material may comprise an average grain size of between 0.1 and 5.0 mm or between 75 and 150 μm or between 0.1 and 1 mm or between 0.1 and 3 mm. The acid neutralizing material may be milled to obtain a uniform grain size by use of common milling equipment such as colloid mills (e.g., ball mills, bead mills), disc mills, jet mills, rotor-stator mixers (ultra turrax) or high-pressure homogenizers. In some embodiments the reaction rate of the acid neutralization may be improved by reducing the particle size of the acid neutralizing agent further still. Generally, material comprising metal silicates (e.g., rock comprising metal silicate minerals) has a wide range of initial particle sizes. As such, it is desirable to comminute the starting material comprising metal silicates, which comminuting may be achieved with any suitable apparatus or combination of apparatus. Size reduction of starting material comprising metal silicates may begin with crushing. Crushed material comprising metal silicates may then be reduced to a smaller particle size by grinding. Grinding may include use of a mill such as a jet mill or ball mill. Ground material comprising metal silicates may then be subsequently screened (e.g., by sieve, cyclone, etc.) to select for material comprising metal silicates within a particular size distribution range. Screened material comprising metal silicates falling outside the particular size distribution range may be passed back into the grinder and further ground. Screened material comprising metal silicates falling within the particular size distribution range may be directly used (i.e., advanced to digestion of the silicate material) or, optionally, passed on to further processing in an iterative process. To effect optimal digestion or dissolution, the material comprising the metal silicate may be comminuted and/or sonicated in solution to further reduce the grain size. In some embodiments, the particle size of the material comprising metal silicates may be reduced to an average diameter of less than 10,000, less than 1000, less than 750, less than 500, less than 400, less than 300, less than 200, less than 100, less than 75, less than 50, less than 25, or less than 10 microns. Further processing of the screen-selected material comprising metal silicates may include magnetic separation to separate magnetic material such as magnetite (Fe₃O₄) followed by optional heat treatment.

In some embodiments a reduction in particle size may be achieved by sonication. In some embodiments the sonication may be ultra sonic and occur at a frequency to induce cavitation of the acid neutralizing agent. In particular, for the manufacturing of superfine-size slurries, ultrasound may have advantages, when compared with commonly used size reduction equipment. Ultrasonication allows for the processing of high-concentration and high-viscosity slurries—therefore reducing the volume to be processed. Ultrasonic milling is especially suited to process micron-size and nano-size materials, such as minerals and metal oxides. In some embodiments the average grain size of the acid neutralizing material may be less that 50 μm, such as between 2 and 10 μm or between 2 and 20 μm after sonication. The particle milling effect may be based on intense ultrasonic cavitation. When sonicating liquids at high intensities, the sound waves that propagate into the liquid media result in alternating high-pressure (compression) and low-pressure (rarefaction) cycles, with rates depending on the frequency. During the low pressure cycle, high-intensity ultrasonic waves create small vacuum bubbles or voids in the liquid. When the bubbles attain a volume at which they can no longer absorb energy, they collapse violently during a high pressure cycle. This phenomenon is termed cavitation. The implosion of the cavitation bubbles results in micro-turbulences and micro-jets of up to 1000 km/hr. Large particles are subject to surface erosion (via cavitation collapse in the surrounding liquid) or particle size reduction (due to fission through inter-particle collision or the collapse of cavitation bubbles formed on the surface). This leads to sharp acceleration of diffusion, mass-transfer processes and solid phase reactions due to crystallite size and structure changing. Methods by which small grain sized, acid neutralizing materials comprising metal silicates or phosphorites are used, alone or in combination with other sources of divalent cations and alkaline solutions are further described below.

Rock, (e.g., naturally occurring solid aggregate comprising minerals and/or mineraloids such as mafic, ultramafic, or felsic rock), is suitable and often convenient for the invention, particularly rock comprising magnesium and/or calcium (e.g., mafic, ultramafic, peridotite, basalt, gabbro, diabase, etc.) that in certain embodiments, upon processing (e.g., size reduction, digestion), raises the pH of an acidic solution and beneficially provides divalent cations such as Mg²⁺ and/or Ca²⁺ for use in a carbon sequestration product. It is desirable to minimize carbon dioxide generation thus, in some embodiments the acid neutralizing material may contain less than 10 wt %, 5 wt % or 1 wt % or 0.5 wt %, or 0.2 wt %, or 0.1 wt % carbonates. In some embodiments the acid neutralizing material is derived from a mined rock or mineral that does not comprise any carbonates. In some embodiments the acid neutralizing material may contain less than 1 wt % MnO. In some embodiments the acid neutralizing rock comprises phosphorus. In some embodiments the acid neutralizing material may release no carbon dioxide upon reaction with an acidic solution. In some embodiments the acid neutralizing material may neutralize 90, 95, or 99% of the acidity in a solution generated in an electrochemical reaction. In some embodiments the residual acidity may be completely neutralized by an alkaline solution. In some embodiments, an electrochemical process may generate enough alkalinity to sequester 1 ton of carbon dioxide and produce between 20 and 50 thousand liters of a 1 M acidic solution (e.g., 3 wt % HCl) or the equivalent amount of acidity such as between 3000 and 7000 liters of a 6 M acidic solution (e.g., 20 wt % HCl). In some embodiments an amount of mafic, ultramafic, or felsic rocks such as 2000 g, 3000 g, 4000 g, or 5000 g may be used to neutralize 99% of the acid.

Mafic minerals comprising metals (e.g., basalt, granite) may also provide silicates (e.g., metal silicates, which contain at least one metal along with silicon such as such as calcium silicates, aluminosilicates, iron-bearing silicates, and mixtures thereof) that, upon processing, may provide acid neutralizing capacity for acidic solutions (e.g., solution produced as part of a carbon sequestration process) and in some embodiments may also provide a source of calcium ion that may be beneficially combined with sequestered carbon dioxide to form a precipitated material. Mafic minerals may also provide silica to compositions of the invention, which compositions exhibit pozzolanic properties. In some embodiments, minerals are processed for their acid neutralizing capacity alone. That is to say, in some embodiments, material comprising acid neutralizing properties and comprise low or negligible amounts of carbonates and with low or negligible amounts of calcium and/or silica may be processed for raising the pH of an acidic solution by at least 0.5, 1.0 or 2.0 pH units, such as from 0 to 2. As rock may be used in the invention, it should be understood that pure or impure minerals are suitable for the invention. Many different materials are suitable for use in the invention, including naturally occurring materials comprising metal silicates such as those present in mafic rocks, ultramafic rocks, granites, minerals, and mineral-rich clays. Metal silicates that may be used in the invention include, but are not limited to basalts comprising orthosilicates, inosilicates, phyllosilicates, and tectosilicates. Orthosilicates include, for example, olivine group minerals ((Mg, Fe)₂SiO₄), wherein olivine minerals richer in magnesium (i.e., closer to forsterite (Mg₂SiO₄) as opposed to fayalite (Fe₂SiO₄)) are generally preferred. Inosilicates (“chain silicates”) include, for example, single chain inosilicates such as pyroxene group minerals (XY(SiₙAl)₂O₆), wherein X represents ions of calcium, sodium, iron (e.g., Fe²⁺), or magnesium and Y represents ions of smaller size, such as chromium, aluminum, iron (e.g., Fe³⁺, even Fe²⁺), magnesium, manganese, scandium, titanium, and vanadium, and wherein pyroxene group minerals richer in magnesium are generally preferred (e.g., closer to institute (Mg₂Si₂O₆) as opposed to ferrosilite (Fe₂Si₂O₆)). Single chain inosilicates also include, for example, pyroxenoid group minerals such as wollastonite (CaSiO₃), commonly in contact-metamorphosed limestone, and pectolite (NaCa₂(Si₃O₈)(OH)), which are also suitable for use in the invention. Double chain inosilicates include, for example, amphibole group minerals such as anthophyllite ((Mg,Fe)₇Si₈O₂₂(OH)₂). Phyllosilicates (i.e., sheet silicates) include, for example, serpentine group minerals (e.g., antigorite, chrysotile, and/or lizardite polymorphs of serpentine ((Mg,Fe)₃Si₂O₅(OH)₄)), phyllosilicate clay minerals (e.g., montmorillonite (NaₙCa)_{0.33}(AlₙMg)₂(Si₄O₁₀)(OH)₂.nH₂O and talc Mg₃Si₄O₁₀(OH)₂), and mica group minerals (e.g., biotite K(Mg,Fe)₃(AlSi₃O₁₀)(OH)₂). Tectosilicates (i.e., framework silicates), which are aluminosilicates (with the exception of quartz group minerals), include, for example, plagioclase feldspars such as labradorite ((Na,Ca)(Si,Al)₄O₈ (Na:Ca 2:3) and anorthite (CaAl₂Si₂O₈). In some embodiments the acid neutralizing agents may be basalt, peridotite, greywacke, ryolite or andesite. The oxidation state of iron may affect the reaction kinetics of neutralization. In some embodiments the rocks or minerals used may be low in iron such as less than 5% or 4% or 3% or 2% or 1%. The neutralization reaction may occur in solution or in a closed vessel.

Ultramafic minerals (i.e., silicate-containing minerals rich in magnesium and iron, sometimes referred to as magnesium silicates) having less than 45% SiO₂, are a subset of some of the metal silicates described above. As such, ultramafic minerals (i.e., generally >18% MgO,) minerals, and products or processed forms thereof, are also suitable for use in the invention. Mafic and ultramafic rocks (generally >90% mafic or ultramafic minerals), which comprise mafic and ultramafic minerals, are suitable for the invention as well. Such rocks include, but are not limited to, basalt pyroxenite, troctolite, dunite, peridotite, basalt, gabbro, diabase, and soapstone. Common rock-forming mafic minerals include olivine, pyroxene, amphibole, and biotite. Significant masses of olivine- and serpentine-bearing rocks exist around the world, particularly in ultramafic complexes, and in large serpentine bodies. Serpentine is an abundant naturally occurring mineral having minor amounts of elements such as chromium, manganese, cobalt and nickel. Serpentine may refer to any or 20 or more varieties belonging to the serpentine group. Olivine is a naturally occurring magnesium-iron silicate ((Mg,Fe)₂SiO₄), which ranges from forsterite (Fo) (MgSiO₄) to fayalite (Fa) (Fe₂SiO₄). As such, olivine may be, for example, Fo₇₀Fa₃₀, wherein the subscript indicates the molar ratio of forsterite (Fo) to fayatite (Fa). Generally, olivine richer in forsterite is preferred. Owing to structure, the olivine group also includes monticellite (CaMgSiO₄) and kirschsteinite (CaFeSiO₄). Wollastonite is a naturally occurring calcium silicate that is also convenient for the invention. In some embodiments basalt may be used as an acid neutralizing agent. In some embodiments the source of basalt may be residual fines obtained from basalt quarries. In some embodiments the source of basalt may be waste product left from basalt that is used in construction (e.g., as building blocks, aggregate, or in the groundwork), making cobblestones, making statues or making stone wool.

Methods

Methods and systems are disclosed for the neutralization of an acid. In some embodiments the methods and systems disclosed provide for the generation of an acidic and an alkaline solution (e.g., in two separate compartments) from an electrochemical reaction. In some embodiments a portion of the alkaline solution may be used to sequester carbon dioxide 140 from a gas. The acidic solution (e.g., pH less than 7) may be used to digest an acid neutralizing material such as a metal silicate or a phosphate in order to raise the pH of the solution (e.g., at least 0.5, 1.0, 2.0 or more pH units). In some embodiments the acid neutralizing material may not release carbon dioxide into the atmosphere during the acid neutralizing process. In some embodiments the electrochemical method may produce no gas such as no chlorine gas or no oxygen. In some embodiments the products of a digestion reaction with a metal silicate or phosphorite may be useful in the carbon dioxide sequestration process.

Provided are methods for neutralizing an acidic solution with an acid neutralizing material such as a metal silicate and/or phosphorite. The neutralization process of this invention beneficially provides an economical and substantially carbon neutral or carbon negative method for sequestering carbon dioxide by neutralizing the acid product of an electrochemical process while utilizing the alkaline solution from the same electrochemical process to sequester carbon dioxide. In some embodiments the acid neutralizing material contains little carbonate or is substantially carbonate free, providing for minimal release of carbon dioxide and thereby providing for an increased amount of carbon sequestration compared to a carbon sequestration process utilizes an electrochemical process that generates an acidic solution requiring neutralization by conventional means (i.e., contact with a carbonate based acid neutralizing agent such as lime) that results in the release of carbon dioxide. Provided are methods for producing carbonate-containing compositions comprising divalent cations such as calcium from an acid neutralizing material. The compositions may utilize carbon dioxide, and a source of proton-removing agents. The methods may yield a carbonate composition and a solution with a pH less than 2. The solution may be suitable for disposal in a subterranean location or in any body of water after digestion of an acid neutralizing material. Provided are methods for producing carbonate-containing compositions comprising silica from a source of carbon dioxide, a divalent cation-containing solution, and a source of proton-removing agents. Also provided are methods for producing carbonate-containing compositions comprising little or no silica. In such methods, silicon-based material (e.g., silica, unreacted or undigested silicate, etc.) may be separated at an early point in the method and processed separately from carbonate-containing compositions. Silica-based material and carbonate-containing material may be blended at a later stage to produce a composition with a particular ratio of components. Carbonate-compositions comprising silica may be further processed and blended with, for example, Portland cement.

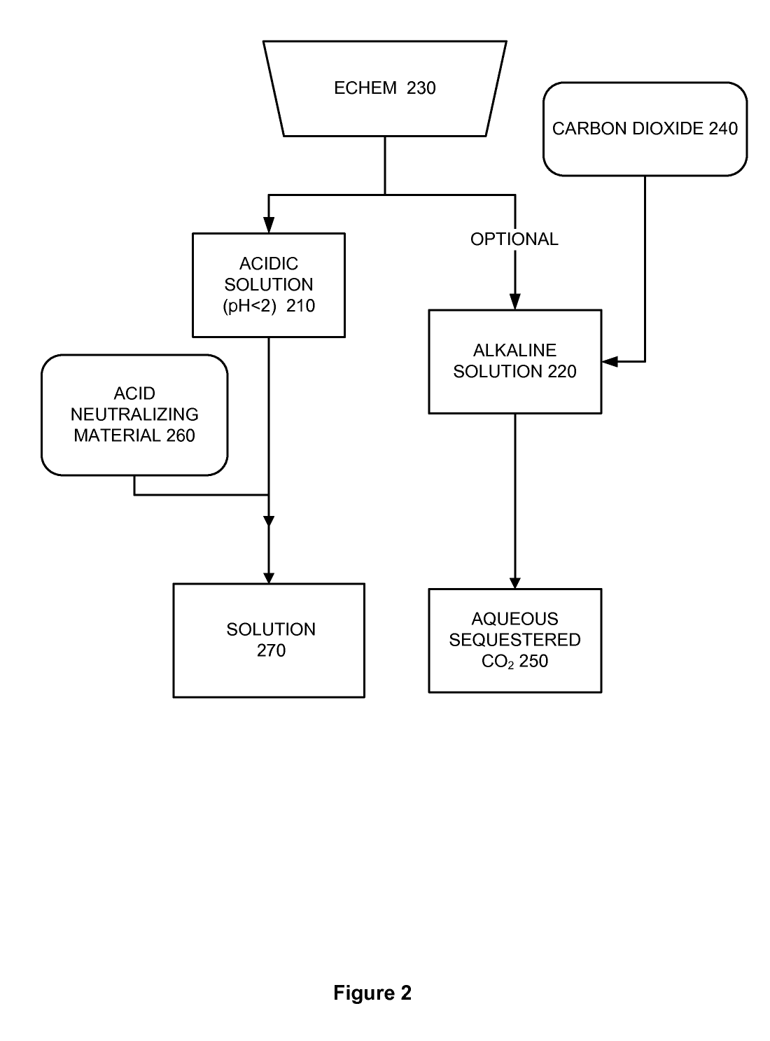

Certain embodiments are disclosed in FIG. 2 and provide for the generation of an acidic 210 and an alkaline 220 solution is two separate compartments from an electrochemical reaction 230. A portion of the alkaline solution may be optionally used to sequester carbon dioxide 240 from a gas and into an aqueous solution 250 or slurry. The acidic solution 210 (e.g., less than pH 7 or 2 or 1.3 or 1 or 0.5 or less than 0.1) may be used to digest an acid neutralizing material such as a metal silicate 260 or a phosphate in order to raise the pH of the solution 270 (e.g., by at least 0.1 or 0.5 or 1 or 2 pH units). In some embodiments the acid neutralizing material may not release carbon dioxide into the atmosphere during the acid neutralizing process. In some embodiments the products of a digestion reaction with a metal silicate or phosphorite may be useful in the carbon dioxide sequestration process.

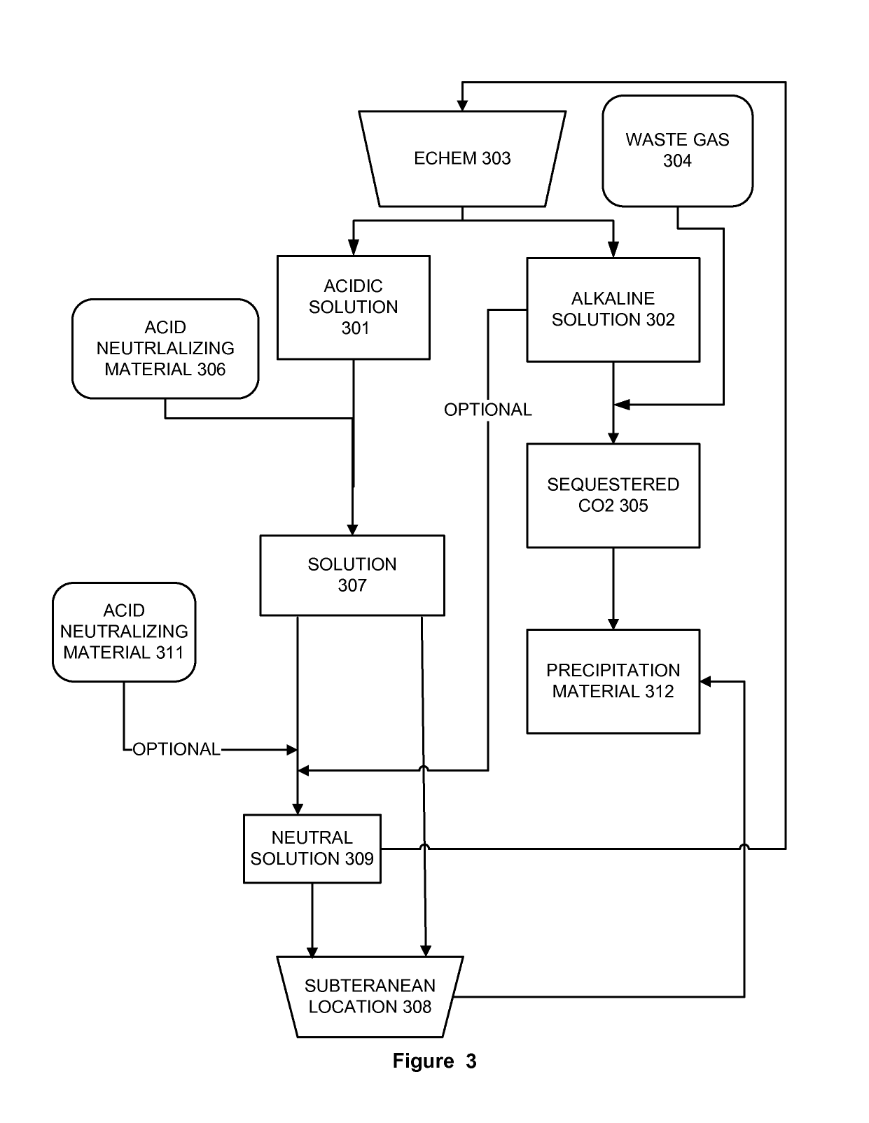

FIG. 3 illustrates another embodiment whereby a general sequence of one or more steps include making an acidic solution (e.g., with a pH less than 0.1 or 0.5 or 1 or 1.3 or 2 or 3 or 7) more neutral using an acid neutralizing material. The steps are discussed in further detail in the following paragraphs. In some embodiments the acid neutralizing material may contain little or no carbonates (e.g., less than 50 wt %, less than 10 wt %, less than 2 wt % less than 1 wt %, less than 0.5 wt % carbonates). An acidic solution 301 and an alkaline solution 302 may be generated by an electrochemical reaction 303. The reaction may be configured to produce no chlorine gas and/or no oxygen gas. The reaction may be configured to operate at less than 2.0 volts or less than 1.8, 1.6, 1.4, 1.2, 1.0 volts between the anode and the cathode. The alkaline solution generated in the electrochemical reaction may be contacted with a gas 304 to sequester carbon dioxide from the gas into an aqueous solution or slurry 305 (e.g., as carbonic acid, bicarbonate, carbonate or a mixture thereof). The acidic solution 301 may be contacted with an acid neutralizing material 306 comprising metal silicates (e.g., basalt) or phosphorite (e.g., apatite). In some embodiments the acid neutralizing material may comprise less than 10 wt %, or 5 wt % or 1 wt % carbonate material. In some embodiments the acid neutralizing material may comprises no carbonate material providing for reduced or no carbon dioxide release as the pH of the solution is raised by at least 0.5 or 2 or 3 or 4 or 5 or 6 or more pH units 307. In some embodiments the acid neutralizing material does not comprise lime or quicklime. Lime comprises large amounts of carbonate material that may be converted to carbon dioxide upon reaction with an acidic solution. Quicklime (CaO), while not comprised of a carbonate material is derived from materials such as limestone that contain calcium carbonate (CaCO₃). Calcium carbonate is conventionally converted to CaO the material to above 825° C., a process called calcinations or lime-burning, liberating carbon dioxide (CO₂); leaving quicklime and so carbon dioxide is indirectly released when quicklime is used to neutralize an acid. In the methods of this invention, the amount carbon dioxide released per increase in pH unit of the acidic solution is reduced compared to the carbon dioxide released when using primarily either lime or quicklime as an acid neutralizing reagent.

The particle size of initial material comprising metal silicates may first be reduced in size (i.e., comminuted) using any method known in the art including sonication as discussed above. The process may be performed iteratively to produce material comprising metal silicates of a consistent particle size. Comminuted material comprising metal silicates may then be digested by the acidic solution 301 in order to raise the pH of the acidic solution units so that solution after digestion 307 has a pH greater than the solution before digestion of the acid neutralizing material, while not releasing carbon dioxide during digestion process. In some embodiments the solution 307 may have a pH greater than 2 and may be released into a directly into a subterranean location 308. In some embodiments the solution 307 may be converted to a completely neutral (pH 7) solution 309 and then be released into a water system or a subterranean location 307. Neutralization of a solution 307 that is has pH greater than 2 may be achieved by contact with conventional acid neutralizing material 311 (e.g., CaO, lime, etc.). In some embodiments neutralization may be achieved by contact with the alkaline solution 302 produced from the electrochemical reaction 303. In some embodiment the neutralized solution 309 or the solution with a pH greater than 2 may be released into a subterranean location 1000 meters or more below ground level. In some embodiments the subterranean location may be an aquifer. In some embodiments the acidic solution 307 may be further neutralized by rocks and minerals in the underground location. The acidic solution 307 may release divalent cations into the aquifer upon contact with subterranean rocks and mineral. The divalent cations may be utilized to form a precipitation material 312 with sequestered carbon dioxide.

The solution 307 after contact with an acid neutralizing material may have with a pH greater than 2 may be neutralized by any means. In some embodiments the neutralization reaction may comprise contacting the solution 307 with portion of the alkaline solution 302. In some embodiments the amount of alkaline solution used to neutralize the acidic solution after contact with the metal silicates of this invention may be 2% or 1% or less of the alkaline solution made by the electrochemical method. This method advantageously provides for a neutralized solution without the release of carbon dioxide and with minimal use of electrochemically generated alkaline solution. In some embodiments the acidic solution may be neutralized by conventional means (e.g., lime, sodium carbonate, calcium oxide etc.) after the pH has been raised by at least 0.5 pH units by an acid neutralizing material derived from a rock or mineral comprising metal silicates. The neutralized solution may then be disposed of by any convenient means, such as transferring the solution to a subterranean location 308. In some embodiments the neutralized solution may have a high ionic strength such as a NaCl concentration between 10 and 90 wt %, between 15 and 40 wt % or between 20 and 30 wt %. In some embodiments a portion of the neutralized solution 309 may recycled into the electrochemical reaction 303, advantageously reducing the amount of sodium chloride utilized to sequester carbon dioxide. This method beneficially provides for the increased sequestration of carbon dioxide without the production of hazardous materials such as concentrated hydrochloric or sulfuric acid.

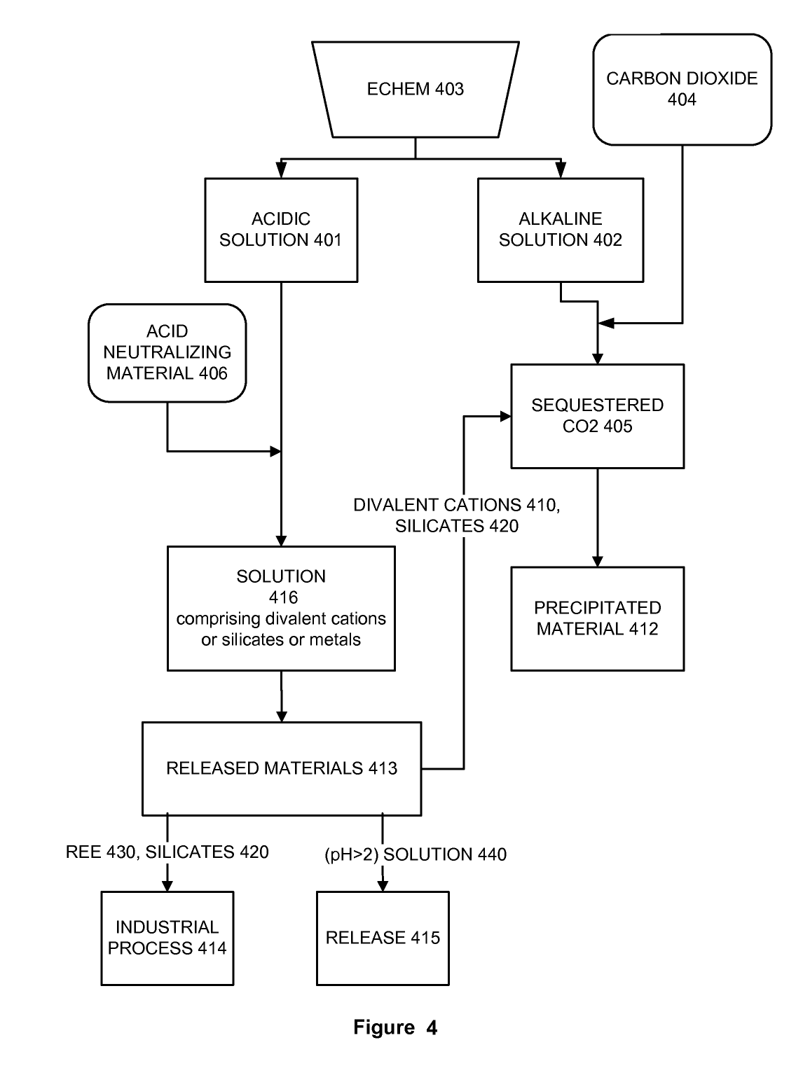

As shown in FIG. 4, the neutralization of an acidic solution 401 (e.g., that has a pH less than 0.1, 0.5, 1, 1.3, 1.5, 2 or 7) generated from an electrochemical reaction 403 may be achieved with an acid neutralizing material 406 comprising metal silicates (e.g., mafic and/or ultramafic rocks and minerals) or phosphorite. The products of that neutralization reaction may be useful in a carbon sequestration process or in any other process. An alkaline solution 402 from the electrochemical reaction 403 may be used to sequester the carbon dioxide 404. The acidic solution 401 and the acid neutralizing material 406 may advantageously provide for divalent cations 410 and/or silicates 420 that may be contacted with sequestered carbon dioxide 405 to form a precipitation material 412 of this invention as well as facilitating the neutralization of a product 401 of an electrochemical reaction 403. In some embodiments the solution 416 after contact with the acid neutralizing material may have a pH greater than the solution before contact by 0.1, 0.2, 0.5, 1, or 2 pH units and provide for released materials 413 from the acid neutralizing material 406 and the acidic solution 401. These materials may include rare earth elements (REE) 420 or metals such as yttrium lanthanum cerium praseodymium neodymium, promethium samarium europium gadolinium terbium dysprosium holmium erbium thulium or ytterbium that may be utilized for an industrial process 414. In some embodiments the acid neutralizing material may comprise metals such as copper, gold, silver, etc., that may be released upon digestion with the acidic solution. In some embodiments the methods of this invention may produce a solution that has a pH of greater than 2 440 that may be released 415 into the environment with little or no additional processing.

In some embodiments the concentration of comminuted acid neutralizing material comprising metal silicates in the suspension may be anywhere from 1 and 1280 g/L in an acidic solution with a pH of less than 2 (e.g., less than 1, or less than 0.5). Digestion of the material comprising metal silicates may continue until the pH of the solution is raised by at least 2 pH units to at least 2. In some embodiments the pH may be raised to at least 3, or 4 or 5. In some embodiments the pH may be raised to at least 6. In some embodiments the pH may be raised at least 3 pH units. In some embodiments the pH may be raised at least 4 or 5 or 6 pH units. As such, digestion conditions (e.g., temperature, mode of agitation (if any), time, etc.) may vary as described below. Digestion, for example, may be performed under ambient conditions (i.e., room temperature and pressure). In some embodiments digestion occurs at between 40 and 100° C. such as between 40 and 80° C. In some embodiments the digestion may occur between 50 and 70° C. In some embodiments the digestion may occur between 50 and 60° C. In some embodiments the acidic solution may be transferred directly from the electrochemical reaction to the acid neutralizing reaction in a manner that utilizes a portion of the thermal energy generated in the electrochemical reaction in order to facilitate the digestion of the metal silicate. Digestion may occur in sequential reaction vessels. Digestion may last any amount of time from hours to days to years. After contact with the acidic solution, the digested material may be a solution or slurry comprising a solution that may have a pH greater than 2, 3, 4, 5, or 6. The solution may comprise dissolved material (e.g., metals, cations, silicates) that may be beneficial to the carbon sequestration process. The solution or slurry may be optionally filtered or separated in a filtering step to remove dissolved metals in the acidic solution (e.g., rare earth metals, calcium, magnesium, or other material) from undigested material (e.g., clay). Calcium may be separated from other dissolved material to provide a solution comprising calcium ions for contact with sequestered carbon dioxide. The silica may be colloidal and removed from the solution during a filtration step or may be dissolved as silicates in the acidic solution. Metals and other material of interest may be dissolved and removed by other means such as an anion exchange column or solvent extraction methods. As the concentration of silica and other silicon-based products of digestion may increase at a faster rate than the concentration of divalent cations, it may be advantageous to filter silica and other silicon-based products to optimize extraction of divalent cations. A precipitation material may then be produced in a precipitation step from the digested material which comprises divalent cations and/or silicates, and the solution comprising sequestered carbon dioxide. In some embodiments the pH of dissolved material may be optionally adjusted (i.e., neutralized) prior to contact with the sequestered carbon dioxide. In some embodiments the dissolved material may be contacted with sequestered carbon dioxide without further processing. As described in additional detail herein, precipitation of a precipitation material further involves contact with sequestered carbon dioxide in the form of carbonic acid, bicarbonate, carbonate or any combination thereof. Precipitation material, upon formation, may then be separated from the precipitation reaction mixture in a separation step which may involve a liquid-solid separator. After separation, the precipitation material may be optionally rinsed in a rinsing step to remove, for example, soluble chlorides, sulfate, nitrates, and/or the like. Whether newly separated in separation step or freshly rinsed as in a rinsing step, the precipitation material may be dried. The acidic solution may be completely neutralized after contact with a metal silicate by any means known in the art, such as contact with sodium hydroxide, calcium oxide, calcium carbonate or the like. The neutralized solution may be released into a water system or utilized in an electrochemical reaction.

Neutralization of an acidic solution by the digestion of metal silicates (e.g., mafic such as basalt and ultramafic rocks such as serpentine and minerals, felsic minerals such as granite) and/or related materials may be achieved using any convenient protocol, wherein the protocol provides for the increase in pH of the acidic solution by at least two pH units and optionally produces divalent cations, and/or silicon-based material for use in the invention. In some embodiments the metal silicate may comprise anorthite (CaAl₂SiO₈). The acidic solution may be contacted with anorthite and become more neutral by at least 2 pH units while releasing calcium into an acidic solution and kaolinite (clay) into a slurry. The calcium may be incorporated into a carbonate precipitation product of this invention. In some embodiments the kaolinite may be separated from the reaction mixture and converted into metakaolin by conventional methods (heating to promote dehydroxilation). The metakaolin may be used for industrial purposes. In some embodiments the metakaolin may be incorporated into carbonate products of this invention such as cements, aggregates, building material supplementary cementitious materials and the like. In some embodiments the kaolin may be stored underground. Digestion of the metal silicate may be accelerated by increasing surface area of the particles, such as by particle size reduction (described above), as well as by use of, for example, ultrasonic techniques (e.g., inertial cavitations).

Acid neutralizing material comprising metal silicates may be contacted with the acidic solution in a variety of processes, including batch, semi-batch, and continuous processes to produce slurry comprising silica containing material and a solution with an increased pH value. In some embodiments, the acid neutralizing material may be mixed with the acidic solution in a tank, to form a slurry or a solution that may be stirred or otherwise agitated. After a period, the slurry or solution is withdrawn from the tank, and the tank may be recharged with fresh material comprising metal silicates. In some embodiments, the reaction may occur in one or more continuous stirred tank reactors in a continuous flow process. In some embodiments, material comprising metal silicates is disposed within a packed column and the acidic solution is percolated through the disposed material comprising metal silicates. In some embodiments, a slurry comprising divalent cations and silicate-containing material is continuously withdrawn from the top of a vertical column, wherein the vertical column is packed with material comprising metal silicates. In some embodiments a batch counter flow system is provided wherein an acidic solution comprising a pH of less than 2 is contacted with an amount of acid neutralizing material that has been previously exposed to an acidic solution. In some embodiments the weight ratio of acid neutralizing material to the acidic solution may be 1:10. In some embodiments 1 liter of an acidic solution that may be 3 wt %, 5 wt %, 10 wt %, 15% wt % HCl is be mixed with 100 g of a acid neutralizing material (e.g., metal silicate such as basalt, phosphorite) and reacted until the pH of the reaction mixture is raised by at least 2 pH units, whereupon a solution comprising divalent cation is separated from the reaction and contacted with sequestered carbon dioxide. The resulting acid neutralizing material may be only partially digested and be comprised mainly of clay or other material with a residual neutralizing capacity.

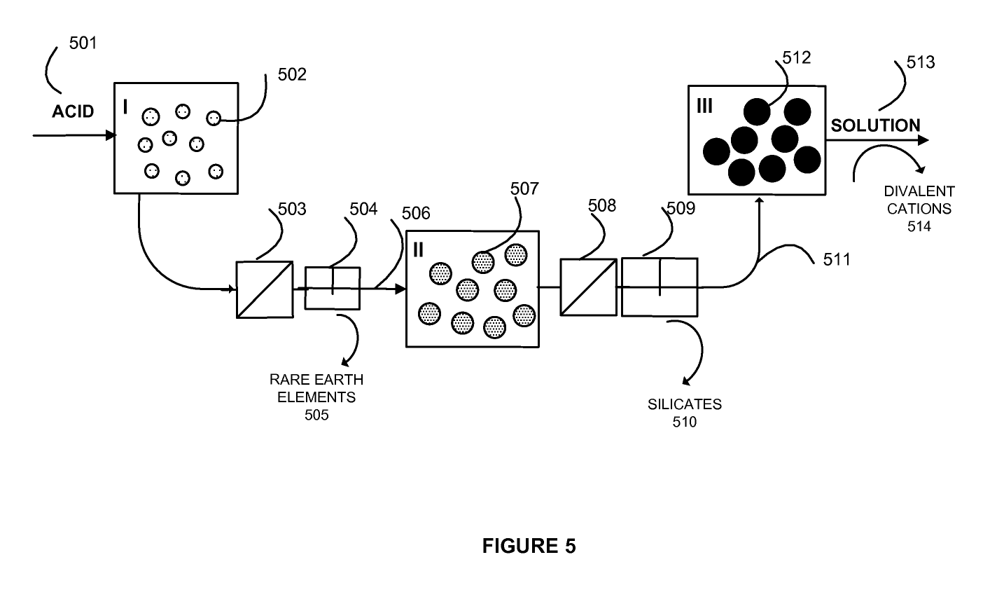

FIG. 5 illustrates an embodiment of this invention wherein an acidic solution is processed though sequential batch reactions to provide for a more neutral solution at each subsequent acid transfer and advantageously separate diverse elements and minerals based on rate of release of the materials from the acid neutralizing material. FIG. 5 shows a series of 3 reaction vessels (I-III). It will be appreciated that any suitable number of vessels may be used. An acidic solution (e.g., with a pH less than 1.3 or 2) 501 is transferred to reaction vessel I that contains acid neutralizing material comprising a metal silicate (e.g., mafic, ultramafic or felsic rocks) that is almost completely depleted of acid neutralizing capacity 502. The acid neutralizing material 502 may be a metal silicate that has been previously digested by an acidic solution in two or more batch reactions. The acid neutralizing material may be completely or almost completely depleted of divalent cations. The acidic solution is contacted with the material that comprises metal silicates depleted of divalent cations for a period of time such as minutes, hours, or days or until the pH of the acidic solution is raised above a defined threshold such as 0.5 pH units, 1 pH unit, 2 pH units or more. The reaction may be sonicated to accelerate the digestion reaction. The digestion of the depleted acid neutralizing material by the acidic solution may yield a slurry comprising sparingly soluble dissolved elements of interest (e.g., rare earth elements or transition metals or precious metals) that are sparingly soluble in acid. The slurry may be filtered 503 and then elements of interest (e.g., earth elements 505 or transition metal) may be separated 504 by any means known in the art (i.e., solvent extraction, precipitation, ion exchange chromatography etc.) to yield a solution of elements of interest and an acidic solution 506 that may be further processed. In some embodiments rare earth elements 505 may be removed from an acid solution by heating the solution, passing the heated solution through an anion exchange column, retaining metals captured on the resin, eluting the captured rare earth element with an appropriate solvent. The solvent may be removed via any solvent extraction system known in the art. Solvent extraction essentially is a separation process based on apparent equilibrium steps. In a majority of hydrometallurgical applications, it may consist of two circuits of apparent equilibrium stages coupled by a common solvent. In a first step, the metal is extracted from an aqueous solution by an organic solvent. In a second step, the metal is recovered from the organic solvent, providing recovery of the solvent and producing a more concentrated and more pure aqueous solution.

The solution 506 may then be transferred to vessel II that contains an intermediately depleted acid neutralizing material 507. In this reaction vessel, the pH of the solution may be raised yet again (e.g., by 0.5 pH units, 1 pH unit, 2 pH units or more). The intermediately depleted acid neutralizing material 507 may be material that has been previously reacted with an acidic solution at least one time. The intermediately depleted acid neutralizing material may be completely or almost completely depleted of divalent cations. The digestion of the depleted acid neutralizing material by the acidic solution may yield a slurry and release elements or compounds of interest that are not divalent cations (e.g., silicates or transition metals that are only sparingly soluble in an acidic solution). Silicates 510 or transition metals or rare earth elements may be removed from the acidic solution by filtering the slurry 508 and separating 509 the silicates 510 or transition elements by methods known in the art, such as ionic exchange columns or resins, solvent extraction and the like. The solution 511 is then transferred to a reaction vessel (III) that contains acid neutralizing material 512 that has not previously been reacted with an acidic solution to form a reaction solution or slurry. The pH of the solution may be raised yet again (e.g., by 0.5 pH units, 1 pH unit, 2 pH units or more) such that the resulting solution 513 has a pH greater than 2. Divalent cations 514 may be released into the solution or slurry. The solution comprising divalent cations 514 may be transferred to a precipitation reaction comprising sequestered carbon dioxide or may be processed further. For example the divalent cations may be purified from the acidic solution by methods known in the art (e.g., solvent extraction, precipitation). In some embodiments the acidic solution may be fully neutralized by sodium hydroxide from the electrochemical reaction.

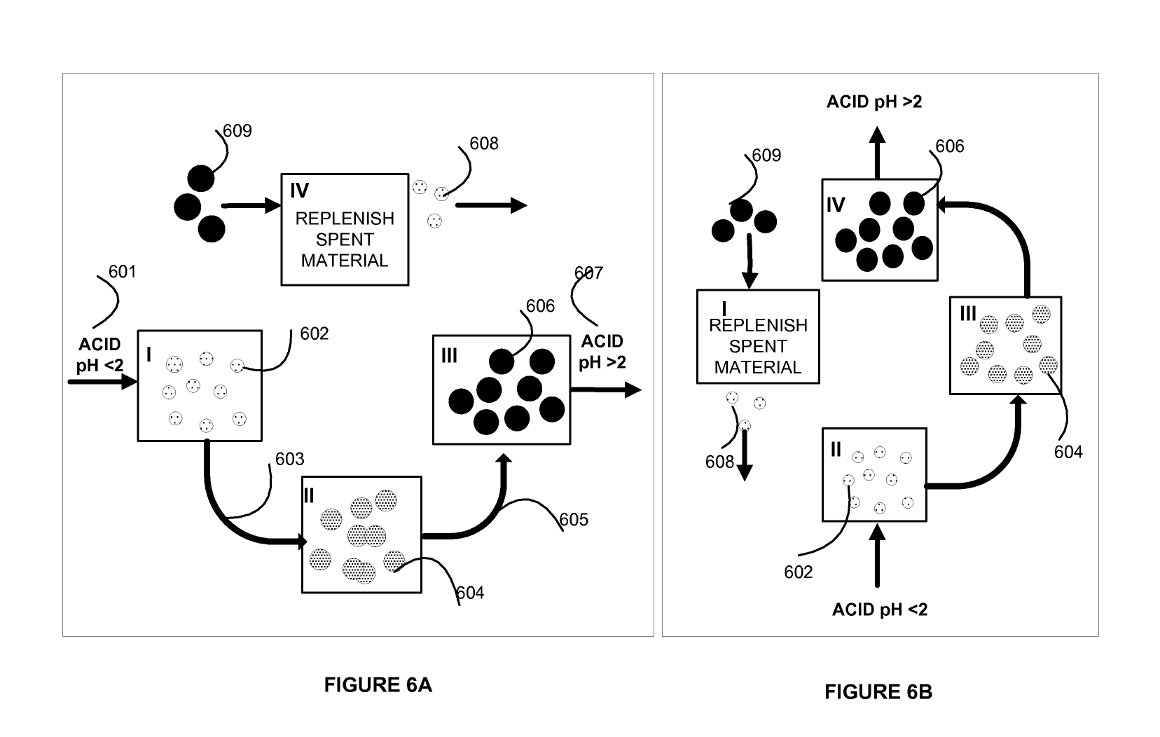

FIGS. 6A and B illustrate an embodiment of the invention that may facilitate the movement of acid through a batch reaction system while advantageously minimizing the transfer of acid neutralizing material. The batch system of this invention may advantageously facilitate the separation of materials released from the acid neutralizing material by an acidic solution. Without being bound to a particular mechanism for separation, the sequential reaction of an acidic solution with a series of acid neutralizing material that are in different states of depletion may facilitate the separation of released material based on the solubility of the material or the kinetics of the reaction with an acidic solution. The batch system may comprise four vessels (I-IV) shown in FIG. 6A. It is understood that various embodiments may comprise any number of vessels to perform this process. The acidic solution 601 may be transferred through vessel I where the acid solution is first reacted with acid neutralizing material has been previously reacted with an acidic solution and is essentially depleted of divalent cations 602. The pH of the resulting acid solution or slurry may rise 0.5, 1, 2 or more units and be treated to remove solids and dissolved elements or compounds of interest. The acidic solution 603 may be transferred to a second reaction vessel (II) where it is reacted with acid neutralizing material that has been previously reacted with an acid solution and is at least partially depleted of divalent cations 604. The pH of the acidic solution or slurry may be raised by 0.5, 1, 2 or more units and be treated to remove solids and dissolved elements or compounds of interest. The acidic solution 605 may be transferred to a third reaction vessel and reacted with acid neutralizing material that has not been reacted with an acidic solution 606. The pH of the resulting acid solution or slurry 607 may rise 0.5, 1, 2 or more units and contain divalent cations. The divalent cations may be used to reaction with sequestered carbon dioxide to form a precipitation material. The method of this invention provides for spent acid neutralizing material 608 to be replenished in vessel IV with fresh acid neutralizing material 609. After the acidic solution is transferred through the vessel I-III, the conduit configuration may be changed so that the acidic solution is transferred through vessels II-IV (FIG. 6B) while the spent acid neutralizing material 608 is replenished with fresh acid neutralizing material 609 in vessel I. Thus the acid neutralizing material that becomes fully depleted in vessel I in FIG. 6A is replenished as shown in FIG. 6B with fresh acid neutralizing material. Vessel II in FIG. 6B becomes the first reaction vessel to receive the acidic solution and contains depleted acid neutralizing material 602 that is essentially depleted of divalent cations as was shown in vessel I in FIG. 6A. Vessel III in FIG. 6B becomes the second reaction vessel to receive the acidic solution and contains intermediately depleted acid neutralizing material 604 as was shown in vessel II in FIG. 6A. Vessel IV becomes the final reaction vessel to receive the acidic solution and contains fresh acid neutralizing material 606. Vessel I may be replenished with fresh acid neutralizing material 609 and spent material 608 may be removed and disposed of. The cycle may be repeated so that the acidic solution may be transferred from vessel to vessel while the acid neutralizing material may be replenished in only one reaction vessel per acid processing cycle.

In some embodiments, the acid neutralizing material may comprise metal silicates that in whole or in part may provide a source of silica or divalent cation for pozzolanic material of the invention while neutralizing the acidic product of an electrochemical reaction. As such, material comprising metal silicates may be the sole source of silica for preparation of the compositions described herein. Material comprising metal silicates may also be used in combination with supplemental sources of silica for preparation of the compositions described herein. Silica may also be used for other industrial purposes, such as the manufacture of tires or other rubber products. In such embodiments, the electrochemical process is a low-voltage electrochemical process as described herein. In some embodiments, the digestion of material comprising metal silicates and/or other rocks and minerals is achieved over a pH range, which pH range includes pH 7.1 to pH 6.5, pH 6.5 to pH 6.0, pH 6.0 to pH 5.5, pH 5.5 to pH 5.0, pH 5.0 to pH 4.5, pH 4.5 to pH 4.0, pH 4.0 to pH 3.5, pH 3.5 to pH 3.0, pH 3.0 to pH 2.5, pH 2.5 to pH 2.0, pH 2.0 to pH 1.5, pH 1.5 to pH 1.0, pH 1.0 to pH 0.5, and pH 0.5 to pH 0.0. For example, in some embodiments, digestion of material comprising metal silicates is achieved between pH 7.1 and pH 6.0, pH 7.1 and pH 5.0, pH 6.0 and pH 4.0, pH 6.0 and pH 3.0, pH 6.0 and pH 2.0, or pH 5.0 and pH 0.0. Furthermore, artisans will appreciate that selection of an appropriate acid for digestion followed by an appropriate proton-removing agent for neutralization of the resultant acidic solution may introduce ionic species that are beneficial to the precipitation material and end product. Selection of appropriate acids and proton-removing agents may also avoid formation of certain ionic species that would otherwise need to be managed using other means (e.g., rinsing, to remove NaCl from precipitation material).

A solution derived from derived from an electrochemical reaction and a (metal silicate comprising a divalent cation and optionally comprising SiO₂) may be contacted with an aqueous solution of sequestered CO₂ using any convenient protocol. Where the CO₂ is a gas, it may be sequestered by contact protocols of interest include, but are not limited to direct contacting protocols (e.g., bubbling the CO₂ gas through the aqueous solution), concurrent contacting means (i.e., contact between unidirectional flowing gaseous and liquid phase streams), countercurrent means (i.e., contact between oppositely flowing gaseous and liquid phase streams), and the like. As such, contact may be accomplished through use of infusers, bubblers, fluidic Venturi reactors, spargers, gas filters, sprays, trays, or packed column reactors, and the like, as may be convenient. In some embodiments, gas-liquid contact is accomplished by forming a liquid sheet of solution with a flat jet nozzle, wherein the CO₂ gas and the liquid sheet move in countercurrent, co-current, or crosscurrent directions, or in any other suitable manner. In some embodiments the contact liquid is an alkaline solution. In some embodiment the alkaline solution is generated from an electrochemical reaction that is configured to generate no chlorine gas or no gas at the annode. See, for example, U.S. Provisional Patent Application No. 61/158,992, filed 10 Mar. 2009, and U.S. Provisional Patent Application No. 61/178,475, filed 14 May 2009, each of which is hereby incorporated by reference in its entirety. In some embodiments, gas-liquid contact is accomplished by nebulizing a precursor to the precipitation reaction mixture such that contact is optimized between droplets of the precipitation reaction mixture precursor an a source of CO₂. In some embodiments, gas-liquid contact is accomplished by contacting liquid droplets of solution having an average diameter of 500 microns or less, such as 100 microns or less, with the CO₂ gas source. See, for example, U.S. Provisional Patent Application No. 61/223,657, filed 7 Jul. 2009, which is hereby incorporated by reference in its entirety. In some embodiments, a catalyst is used to accelerate the dissolution of carbon dioxide into solution by accelerating the reaction toward equilibrium; the catalyst may be an inorganic substance such as zinc dichloride or cadmium, or an organic substance such as an enzyme (e.g., carbonic anhydrase).

In methods of the invention, a volume of CO₂-charged solution produced as described above is subjected to carbonate compound precipitation conditions sufficient to produce a carbonate-containing precipitation material and a supernatant (i.e., the part of the precipitation reaction mixture that is left over after precipitation of the precipitation material). Any convenient precipitation conditions may be employed, which conditions result in production of a carbonate-containing precipitation material comprising divalent cations from a metal silicate (optionally with SiO₂) from the CO₂-charged reaction mixture. Precipitation conditions include those that modulate the physical environment of the CO₂-charged precipitation reaction mixture to produce the desired precipitation material. For example, the temperature of the CO₂-charged precipitation reaction mixture may be raised to a point at which precipitation of the desired carbonate-containing precipitation material occurs, or a component thereof (e.g., CaSO₄(s), the sulfate resulting from, for example, sulfur-containing gas in combustion gas or sulfate from seawater). In such embodiments, the temperature of the CO₂-charged precipitation reaction mixture may be raised to a value from 5° C. to 70° C., such as from 20° C. to 50° C., and including from 25° C. to 45° C. While a given set of precipitation conditions may have a temperature ranging from 0° C. to 100° C., the temperature may be raised in certain embodiments to produce the desired precipitation material. In certain embodiments, the temperature of the precipitation reaction mixture is raised using energy generated from low or zero carbon dioxide emission sources (e.g., solar energy source, wind energy source, hydroelectric energy source, waste heat from the flue gases of the carbon dioxide emitter, etc.). In some embodiments, the temperature of the precipitation reaction mixture may be raised utilizing heat from flue gases from coal or other fuel combustion. Pressure may also be modified. In some embodiments, the pressure for a given set of precipitation conditions is normal atmospheric pressure (about 1 bar) to about 50 bar. In some embodiments, the pressure for a given set of precipitation materials is 1-2.5 bar, 1-5 bar, 1-10 bar, 10-50 bar, 20-50 bar, 30-50 bar, or 40-50 bar. In some embodiments, precipitation of precipitation material is performed under ambient conditions (i.e., normal atmospheric temperature and pressure). The pH of the CO₂-charged precipitation reaction mixture may also be raised to an amount suitable for precipitation of the desired carbonate-containing precipitation material. In such embodiments, the pH of the CO₂-charged precipitation reaction mixture is raised to alkaline levels for precipitation, wherein carbonate is favored over bicarbonate. The pH may be raised to pH 9 or higher, such as pH 10 or higher, including pH 11 or higher. For example, when a proton-removing agent source such as fly ash is used to raise the pH of the precipitation reaction mixture or precursor thereof, the pH may be about pH 12.5 or higher.

Accordingly, a set of precipitation conditions to produce a desired precipitation material from a precipitation reaction mixture may include, as above, the temperature and pH, as well as, in some instances, the concentrations of additives and ionic species in solution. Precipitation conditions may also include factors such as mixing rate, forms of agitation such as ultrasonic agitation, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate-containing precipitation material according to the invention (from start [e.g., digestion of material comprising metal silicates] to finish [e.g., drying precipitation material or forming precipitation material into pozzolanic material]) may be batch, semi-batch, or continuous protocols. It will be appreciated that precipitation conditions may be different to produce a given precipitation material in a continuous flow system compared to a semi-batch or batch system.

Carbonate-containing precipitation material, following production from a precipitation reaction mixture, is separated from the reaction mixture to produce separated precipitation material (e.g., wet cake) and a supernatant. Precipitation material according to the invention may contain SiO₂; however, if silicon-based material was separated after digestion of material comprising metal silicates, the precipitation may contain very little or no SiO₂. The precipitation material may be stored in the supernatant for a period of time following precipitation and prior to separation (e.g., by drying). For example, the precipitation material may be stored in the supernatant for a period of time ranging from 1 to 1000 days or longer, such as 1 to 10 days or longer, at a temperature ranging from 1° C. to 40° C., such as 20° C. to 25° C. Separation of the precipitation material from the precipitation reaction mixture is achieved using any of a number of convenient approaches, including draining (e.g., gravitational sedimentation of the precipitation material followed by draining), decanting, filtering (e.g., gravity filtration, vacuum filtration, filtration using forced air), centrifuging, pressing, or any combination thereof. Separation of bulk water from the precipitation material produces a wet cake of precipitation material, or a dewatered precipitation material. As detailed in U.S. 61/170,086, filed Apr. 16, 2009, which is herein incorporate by reference, use of liquid-solid separators such as Epuramat's Extrem-Separator (“ExSep”) liquid-solid separator, Xerox PARC's spiral concentrator, or a modification of either of Epuramat's ExSep or Xerox PARC's spiral concentrator, provides for separation of the precipitation material from the precipitation reaction mixture.

In some embodiments, the resultant dewatered precipitation material is then dried to produce a product (e.g., a cement, a pozzolanic cement, or a storage-stable CO₂-sequestering product). Drying may be achieved by air-drying the precipitation material. Where the precipitation material is air dried, air-drying may be at a temperature ranging from −70° C. to 120° C. In certain embodiments, drying is achieved by freeze-drying (i.e., lyophilization), wherein the precipitation material is frozen, the surrounding pressure is reduced, and enough heat is added to allow the frozen water in the precipitation material to sublime directly into gas. In yet another embodiment, the precipitation material is spray-dried to dry the precipitation material, wherein the liquid containing the precipitation material is dried by feeding it through a hot gas (e.g., a gaseous waste stream from the power plant), and wherein the liquid feed is pumped through an atomizer into a main drying chamber and a hot gas is passed as a co-current or counter-current to the atomizer direction. Depending on the particular drying protocol, the drying station (described in more detail below) may be configured to allow for use of a filtration element, freeze-drying structure, spray-drying structure, etc. In certain embodiments, waste heat from a power plant or similar operation may be used to perform the drying step when appropriate. For example, in some embodiments, aggregate is produced by the use of elevated temperature (e.g., from power plant waste heat), pressure, or a combination thereof.

Following separation of the precipitation material from the supernatant, the separated precipitation material may be further processed as desired; however, the precipitation material may simply be transported to a location for long-term storage, effectively sequestering CO₂. For example, the carbonate-containing precipitation material may be transported and placed at a long-term storage site, for example, above ground (as a storage-stable CO₂-sequestering material), below ground, in the deep ocean, etc.

In some embodiments, a method is provided comprising digesting a material comprising a metal silicate with an acidic solution that has a pH of 1 or 0.5 or 0 to release divalent cations and optionally a material comprising SiO₂ and generate acidic solution with a pH above 2. In some embodiments the released divalent cations may be contacted with dissolved carbon dioxide to produce precipitation material. In some embodiments, the method further comprises separating the precipitation material from the supernatant with a liquid-solid separator, drying the precipitation material, processing the precipitation material to produce a construction material, or a combination thereof. As such, in some embodiments, the method further comprises separating the precipitation material from the supernatant with a liquid-solid separator. In such embodiments, the liquid-solid separator is selected from a liquid-solid separator comprising a baffle such as Epuramat's Extrem-Separator (“ExSep”) liquid-solid separator. For example, in some embodiments, precipitation material is separated from precipitation reaction mixture by flowing the reaction mixture against a baffle, against which supernatant deflects and separates from particles of precipitation material, which is collected in a collector. In some embodiments, the liquid-solid separator is selected from a liquid-solid separator comprising a spiral concentrator such as Xerox PARC's spiral concentrator. For example, in some embodiments, precipitation material is separated from precipitation reaction mixture by flowing the reaction mixture in a spiral channel separating particles of precipitation material from supernatant and collecting the precipitation material in an array of spiral channel outlets. In some embodiments, the method further comprises drying the precipitation material. In such embodiments, the precipitation material may be dried to form a fine powder having a consistent particle size (i.e., the precipitation material may have a relatively narrow particle size distribution). Precipitation material, as described further herein, may have a Ca²⁺ to Mg²⁺ ranging from 1:1000 to 1:1 or 1 to 1000:1. Precipitation material comprising MgCO₃ may comprise magnesite, barringtonite, nesquehonite, lansfordite, amorphous magnesium carbonate, artinite, hydromagnesite, or a combination thereof. Precipitation material comprising CaCO₃ may comprise calcite, aragonite, vaterite, ikaite, amorphous calcium carbonate, monohydrocalcite, or combinations thereof. In some embodiments the precipitation material may be greater that 50% vaterite. In some embodiments, the method further comprises processing the precipitation material to produce a construction material. In such embodiments, the construction material is an aggregate, cement, cementitious material, supplementary cementitious material, or a pozzolan.

As above, acid neutralizing material comprising metal silicates (e.g., rock comprising metal silicate minerals) or phosphorites may have a wide range of initial particle sizes. As such, it is desirable to comminute the starting material comprising metal silicates, (e.g., mafic mineral). Crushing, grinding, screening the mafic mineral, followed by optional magnetic separation of screened mafic material and optional heat treatment (e.g., waste heat from flue gas) of separated mafic may be used for size reduction prior to contact with and acidic solution. In some embodiments, the mafic or ultramafic minerals used has, or is reduced to, a particle size of less than 500 μm in order to increase reactivity with an acidic divalent cation-containing solution. A slurry comprising SiO₂ may be formed by contacting a mafic or ultramafic mineral with an acidic solution (e.g., a pH less than 0.5) until the pH of the slurry has increased at least 2 pH units greater than the starting acidic solution. Mafic and ultramafic minerals, as described above, are metal silicates comprising magnesium, calcium, iron aluminum or any combination thereof, which minerals include, but are not limited to, feldspar, olivine, basalt, anorthite, or serpentine. The acid neutralizing material used in methods of this invention may be a mixture of such mafic and ultramafic minerals. Silica resulting from digestion of mafic or ultramafic minerals may be present as, for example, a colloidal suspension (e.g., slurry) or a gel. The silica may be partially amorphous or wholly amorphous. In some embodiments, silica resulting from digestion of mafic mineral may be partially amorphous. In some embodiments, silica resulting from digestion of mafic mineral may be wholly amorphous. Silica may be present as silica acid or a conjugate base thereof, including species such as metasilicic acid (H₂SiO₃), orthosilicic acid (H₄SiO₄), disilicic acid (H₂Si₂O₅), and/or pyrosilicic acid (H₆Si₂O₇). Silicon species such as H₃SiO₃, H₂SiO₃, H₄SiO₃, and the like, may also be present. In addition to silica, slurry produced by contact of the acidic solution with the metal silicate mineral may be enriched in silicates, carbonates, and various cations present in the original mafic mineral such as magnesium, aluminum, and iron cations. Small particles of the original mafic mineral and polymorphs of the mafic mineral may also be present.

In some embodiments reactants may be optionally added to the precipitation reaction mixture. For example, additional acids and proton-removing agents may be added to stabilize pH in a desired range. Selection of appropriate acids and proton-removing agents may result in addition of supplemental divalent cations such as Ca²⁺ and Mg²⁺. In addition, selection of appropriate acids and proton-removing agents may result in addition of supplemental anions such as CO₃²⁻, which may serve to increase the yield of carbonate-containing precipitation material. In some embodiments, transition metal catalysts such as nickel derived from the acid neutralizing material may be added to induce the formation of larger particles during the precipitation process. In some embodiments, the precipitation reaction mixture comprising carbonate-containing precipitation material is processed in a step to separate the carbonate-containing precipitation material from the precipitation reaction mixture leaving a supernatant, which supernatant may comprise unused divalent cations. Such a liquid-solid separation may be accomplished, for example, by flocculating and/or allowing the precipitation material to settle in a settling tank. Liquid-solid separation may also be achieved by a liquid-solid separation technique such as centrifuging. In embodiments in which the silicon-based material from digestion of material comprising metal silicates is not separated from the divalent cation-containing solution the precipitation material results in a mixture of silicon-based material and carbonates (e.g., magnesium carbonate, calcium carbonate).

A pozzolanic material may be produced from precipitation material 412 produced in accordance with the method from FIG. 4. In some embodiments, precipitation material comprising both SiO₂ and carbonates is dried together to form pozzolanic material. In some embodiments, where silica-based material is separated from the divalent cation-containing solution, the silicon-based material and carbonate-containing precipitation material are dried separately and then mixed to form the pozzolanic material. In some embodiments, silicon-based material and carbonate-containing precipitation material are mixed when either one material, or both, when wet. In such embodiments, the subsequent wet-mixed material is then dried to produce pozzolanic material. It will be appreciated that any of the materials (e.g., silica-based material, carbonate-containing precipitation material, silica-and-carbonate-containing precipitation material, and wet-mixed pozzolanic material) may be optionally washed with water before drying.

In some embodiments, pozzolanic material produced by the methods disclosed herein is employed as a construction material. To be employed as a construction material, pozzolanic material may be processed for use as a construction material or processed for used in an existing construction material for buildings (e.g., commercial, residential) and/or infrastructure (e.g., roads, bridges, levees, dams, etc.). The construction material may be a constituent of a structural or nonstructural component of such buildings and infrastructure. An additional benefit of using pozzolanic material as a construction material or in a construction material is that CO₂ employed in the process (e.g., CO₂ obtained from a gaseous waste stream) is effectively sequestered in the built environment. In some embodiments, a precipitation system of the invention may be co-located with a building products factory such that the co-location facilitates processing of pozzolanic material into construction material. In some embodiments, pozzolanic material is utilized to produce aggregates. Such aggregates, methods for their manufacture, and use of the aggregate are described in co-pending U.S. patent application Ser. No. 12/475,378, filed 29 May 2008, the disclosure of which is incorporated herein by reference in its entirety.

In some embodiments an electrochemical reaction may generate an alkaline solution and an acidic solution. The alkaline solution may be used to sequester carbon dioxide from a gas into a solution comprising bicarbonate, carbonate, carbonic acid, dissolved carbon dioxide or any combination thereof. The acid solution may be introduced into a subterranean formation that comprises and acid neutralizing material such as a metal silicate (e.g., basalt). The acidic solution may have a pH less than 2 or less than 1. The subterranean formation may be 50 or 100 or 200 or 300 or 500 or 1000 meters or more below the surface.

Systems

Systems for performing methods of this invention include an electrochemical system configured to generate an acidic solution in a compartment and an alkaline solution in a separate compartment. Each compartment may be operably connected to separate conduits for transporting the acidic solution and the alkaline solution. In some embodiments the acid transfer conduit may be suitable for the transfer an acidic solution with a pH less than 2 or less than 1.3. The electrochemical system may be suitable for generating an acidic solution and an alkaline solution but may not be suitable for the production of a gas such as chlorine gas (e.g., the system may utilize a hydrogen gas diffusion anode. The electrochemical system may operate at 2 volts (V) or less. In some embodiments the electrochemical reaction may proceed after a voltage of less than 2 or less than 1.8 or less that 1.5 volts is applied between the anode and the cathode.

The conduits and vessels may be made or coated with the appropriate materials for allowing the processes to occur in a corrosion resistant manner. In some embodiments the conduits may be configured to transport an acidic solution with a pH of less than 0, or 0.5 or 1.0 or 1.3, or 2.0. In some embodiments the conduits may be insulated in order minimize heat loss in the acidic solution. In some embodiments the electrochemical system may be configured to not release chlorine gas. Systems for use of this invention include a reaction vessel operably connected to a source of acid neutralizing material (e.g., metal silicates, phosphorites) and operably connected to the compartment of the electrochemical system that contains an acidic solution. The system may be suitable for the neutralization of the acidic solution by at least 0.5 pH units. The reaction vessel may be configured for controlling the temperature of the neutralization reaction. The reaction vessel may be suitable for promoting the contact between an acidic solution and an acid neutralization material. For example, the reaction vessel may comprise an agitation system or inert material that may promote contact or dissolution of the materials. For example the reaction vessel may have a heat probe and a heating element. In some embodiments the reaction vessel may be insulated to maintain the temperature of the acidic solution.

The systems of this invention may include liquid solid separation apparatus for filtering solid particles of digested or partially acid neutralizing material from the acidic solution operably connected to a reaction vessel for digesting a acid neutralizing material with an acid. The liquid solid separation apparatus may be suitable for withstanding an acidic solution that is less that pH 1 or 2 or 3 or 4 or 5 or 6 (e.g. corrosion resistant piping or linings). The filtering apparatus may be configured to separate fully depleted acid neutralizing material such as clay from rocks or minerals that may have further capacity as a pH raising agent. The filtering apparatus may be operably connected to a separation apparatus such as a solvent extraction system. For example the solvent extraction system may comprise a pumper tank; one or more auxiliary mixing tanks a settler tank and transfer piping. The solvent extraction system may be configured to remove alkaline earth metals rare earth elements, transition metals, silicates or any combination thereof from an acidic solution. The system may be configured to monitor and adjust mass transfer, mixing efficiency and entrainment levels. The system of this invention may comprise conduits operably connected to the reaction vessel configured to deliver a solution (e.g., with a pH of greater than 2) to an underground location.

The reaction vessel may be operably connected to a precipitation reaction vessel. The precipitation reaction vessel may be further configured for adjusting and controlling precipitation reaction conditions such as one or more precipitation control systems. For example, the precipitation reaction vessel may have a temperature probe and heating element, both of which may be used to control the temperature of the precipitation reaction mixture. A liquid-solid separator may be operably connected to the precipitation reaction vessel and configured to receive precipitation reaction mixture from the precipitation reaction vessel. The liquid-solid separator may be further configured to separate the precipitation reaction mixture into two streams, which streams comprise supernatant and precipitation material. The resultant precipitation material may be a relatively moist solid or a slurry more rich in precipitation material than the original precipitation reaction mixture, either of which may optionally be provided to a dryer configured to receive concentrated precipitation material.

The dryer (e.g., spray dryer), which may accept waste heat from the industrial waste source of CO₂, may produce a dried precipitation or pozzolanic material. The source of the waste gas operably connected to a precipitation reactor and or the dryer may be, in some embodiments, a fossil fuel-fired power plant, a refinery, or some other industrial process that emits an exhaust gas with an elevated concentration of CO₂ relative to the atmospheric level of CO₂. In some embodiments, such exhaust gas is produced by a combustion reaction and therefore the exhaust gas carries residual heat from the combustion reaction. If the distance from the source of the exhaust gas is extensive, or if the exhaust gas is otherwise not sufficiently hot for the purpose of spray drying, a gas heating unit may be placed between the source of the exhaust gas and the spray dryer to boost the temperature of the exhaust gas. It will be appreciated that, in addition to oxidizing exhaust gases produced by combustion, the source of the exhaust gas may be replaced with a source of a reducing gas such as syngas, shifted syngas, natural gas, hydrogen, or the like, so long as the reducing gas includes CO₂. Other suitable multi-component gaseous streams include turbo charged boiler product gas, coal gasification product gas, shifted coal gasification product gas, anaerobic digester product gas, wellhead natural gas streams, reformed natural gas or methane hydrates, and the like.

The digestion reaction vessel may be operably connected to a vessel configured for holding divalent cations. The vessel may be the precipitation reactor. The vessel may be in some embodiments, a holding tank that may be filled with seawater, a brine, or some other divalent cation-containing solution as mentioned above. The holding tank may allow contaminants such as silt, sand, small rocks, and other particulate matter to settle out of the divalent cation-containing solution before the divalent cation-containing solution is introduced into precipitation reactor. Filters may also be employed.

### EXAMPLES

### Example 1

### Neutralization of HCL with Mafic (Basalt) and Ultramafic Rocks

Starting Materials include Basalt from the Snake River Basin, Id. that is predominantly calcium-alumino-silicate, labradorite, and augite.

TABLE 1
Composition of basalt as measured by XRF

| | |
|---|---|
| SiO₂ | 50.22% |
| Al₂O₃ | 13.602% |
| Fe₂O₃ | 12.118% |
| CaO | 11.313% |
| MgO | 7.053% |
| TiO₂ | 2.4236% |
| Na₂O | 2.39% |
| K₂O | 0.4558% |
| MnO | 0.1403% |
| Cl | 0.0365% |
| CO₃ | 0.003167% |
| P₂O₅ | 1404 ppm |
| Cr | 511.2 ppm |
| Sr | 327.8 ppm |
| Zr | 136.1 ppm |
| Y | 23.2 ppm |
| Se | 18.2 ppm |
| Nb | 12.4 ppm |
| Rb | 8.82 ppm |
| As | 3.23 ppm |

Starting Materials include Ultramafic rock from Del Peurto Canyon, Calif. that is predominantly lizardite and forsterite

TABLE 2
Composition of ultramafic rock as measured by XRF

| | |
|---|---|
| MgO | 37.72% |
| SiO₂ | 35.172% |
| CO₃ | 13.21% |
| Fe₂O₃ | 10.182% |
| Al₂O₃ | 0.402% |
| Na₂O | 0.355% |
| CaO | 0.333% |
| MnO | 0.1209% |
| Cl | 0.0971% |
| SO₃ | 0.0422% |
| K₂O | 0.032% |
| Cr | 3107 ppm |
| Zn | 45 ppm |

Rock Preparation: a rock hammer or rock saw was used to break large chunks into pieces small enough to fit in the shatter box (about 1-2″ diameter). Smaller pieces were placed in a shatterbox shattered for 20 seconds, and then removed to rock to sieve. Using a 300 μm sieve on top of a 150 μm sieve on top of 75 μm sieve the rocks were separated by shaking for 2-3 minutes. The portion that is >300 μm size was returned back into the shatter box for further processing. The process was repeated i.e., breaking up the rock (for 10-20 sec) and sieving (for 2-3 min) until most rock passes through the 300 μm sieve. The rock was washed with acetone by pouring the size fraction of interest (usually 75-150 um) into a vessel and covering it with acetone to soak, followed by “filtering” the slurry through the 75 um sieve. After the rock powder dried, it was re-sieved using the shaker for 4 minutes. This procedure removed most of the fines.

Batch Reactions: A 10:1 mass ratio of 1M HCl and processed rock particles was prepared. It was sampled regularly to follow the progress of reaction at 1 hr, 3 hrs, 6 hrs, 24 hrs, 48 hrs, 7 days, and 14 days intervals by withdraw 5 ml volumes of solution using a syringe. Basalt was digested at 40° C. and 80° C. Ultramafic rock was digested at 40° C. Samples were filtered through a 0.22 μm syringe filter into the empty vial. After allowing the solution to cool to near 25° C., measure the pH of the sample.

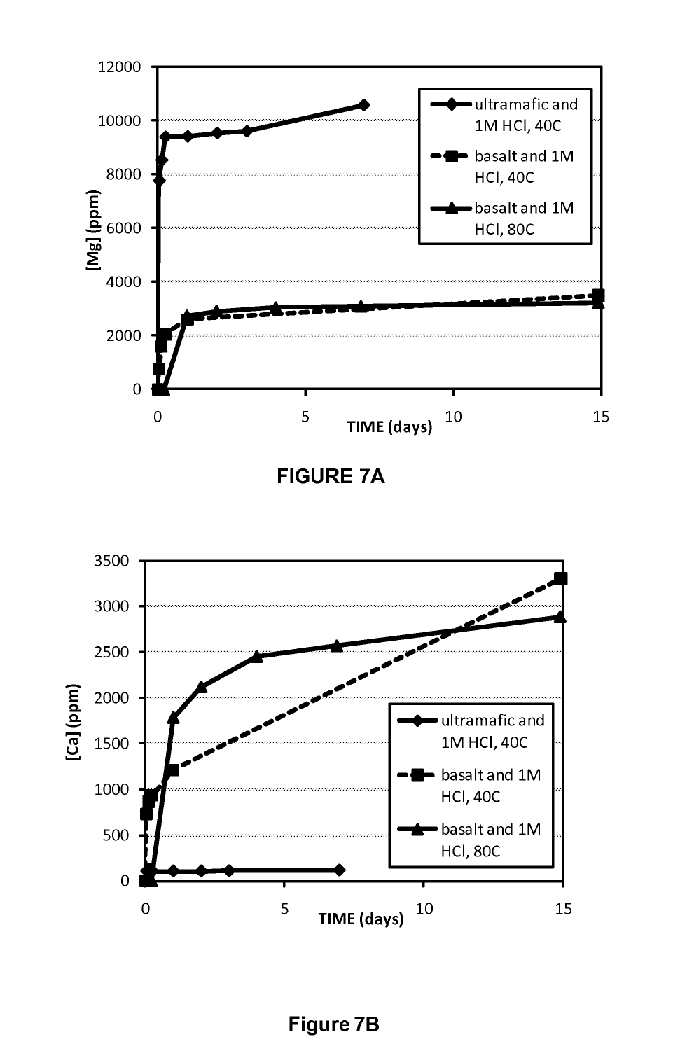

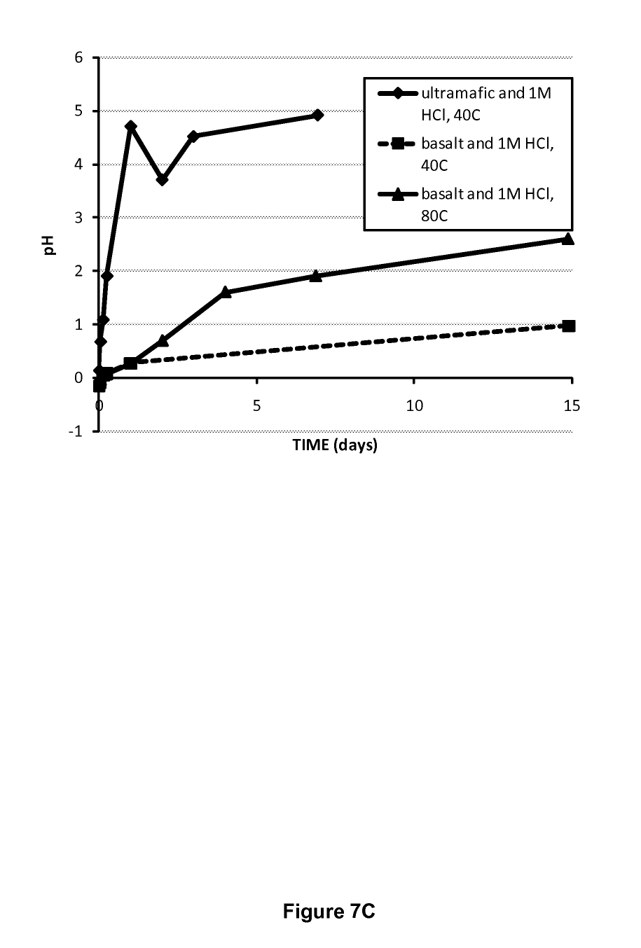

Results: Solution data for three experiments are presented in FIGS. 7A-7C. These data show the progression of calcium concentrations, magnesium concentrations, and pH versus time. All elements were measured using inductively coupled plasma atomic emission spectroscopy (ICP-OES). It can be seen in FIG. 7A ultra mafic rocks release more magnesium than mafic rocks such as basalt. It can be seen in FIG. 7B that very little calcium was obtained from ultramafic rock, consistent with the low amount of calcium available in that type of rock. However, the ultramafic rock neutralized the acid more completely and significantly faster than the basalt as shown in FIG. 7C. Thus, it may be concluded that ultramafic rocks are more efficient at neutralizing acid than mafic rocks, but their low calcium content makes them less viable for generating a high calcium stream. Mafic rocks may generate calcium for a reaction with a sequestered carbon dioxide and provide sufficient neutralization capacity for an acidic solution. Ultramafic rocks produce waters with extremely high magnesium content, so if a magnesium carbonate is the desired product this type of rock will be a good candidate for HCl neutralization. The data also show that the reaction temperature may be an important consideration in the neutralization process. The calcium and magnesium release from mafic and ultramafic rock may be less temperature dependent than neutralization.

### Example 2

### Digestion of Olivine

Summary: Olivine was digested with acid.

Material comprising metal silicates: Olivine, having a mean particle size of 54.3 μm was obtained from Olivine Corp (Bellingham, Wash.). A jet mill was used to reduce a fraction of olivine to a mean particle size of 5.82 μm.

Method: Digestion of olivine was achieved at room temperature (20-23° C.) by stirring olivine into 10% HCl (aq) (5.54 g of olivine (54.3 μm) into 419.37 g 10% HCl). Olivine was leached for four days before measuring concentration of aqueous magnesium by potentiometric EDTA titrations.

Results and Observations: Concentration of Mg²⁺ was determined in the experiment by EDTA titration with a calcium ion selective electrode. The experiment for olivine yielded a Mg²⁺ concentration of 0.1564 M after four days of leaching.

### Example 3

### Digestion of Serpentine

Summary: Serpentine was digested with acid.

Material comprising metal silicates: Serpentine was obtained from KC Mining (King City, Calif.).

Method: Digestion of serpentine was achieved at room temperature (20-23° C.) by serpentine into 10% HCl (aq) (5.03 g serpentine into 415.32 g 10% HCl). Serpentine was leached for four days before measuring concentration of aqueous magnesium by potentiometric EDTA titrations.

Results and Observations: Concentration of Mg²⁺ was determined in the experiment by EDTA titration with a calcium ion selective electrode. The experiment for serpentine yielded a Mg²⁺ concentration of 0.1123 M after four days of leaching.

### Example 4

### Preparation of Precipitation Material from Olivine

Summary: Carbonate-containing precipitation material was prepared using olivine as a raw material. Olivine was digested with acid. Precipitation of precipitation material involved injecting carbon dioxide and adding proton-removing agent to material comprising metal silicates leachate (e.g., olivine leachate). Characterization of precipitation material prepared from olivine leachate indicated a solid product that was predominantly nesquehonite (77%), along with an unidentified amorphous silicon-containing compound. Minor constituents were halite and an unidentified iron salt.

Material comprising metal silicates: Olivine, having a mean particle size of 54.3 μm was obtained from Olivine Corp (Bellingham, Wash.). A jet mill was used to reduce a fraction of olivine to a mean particle size of 5.82 μm.

Method: Olivine was digested at a temperature of 50° C. by stirring material comprising metal silicates into 10% HCl (aq) (10.01 g of jet milled olivine into 475.66 g 10% HCl). Samples were taken periodically to measure concentration of aqueous magnesium. Stirring was maintained for 10 hours, after which the mixture was allowed to sit at room temperature for an additional 9 hours. The mixture was vacuum filtered while hot, and the resultant filtrate (404.52 g) was allowed to cool to room temperature.

The filtrate was neutralized over a period of 1 hour, after which 100% CO₂ was heavily sparged throughout the magnesium-containing solution. With stirring, 15.01 g of NaOH(s) was added followed by an additional 5.23 g of NaOH (aq) (50% w/w), producing carbonate-containing precipitation material. The final pH of the precipitation reaction mixture was pH 8.9. The precipitation reaction mixture slurry was vacuum filtered, and the resultant filter cake was dried in an oven at 50° C. for 17 hours.

The dried precipitation material was characterized by XRD for identification of crystalline phases, SEM for observation of morphology, EDS and XRF for elemental analysis, and carbon coulometry for determination of percent weight inorganic carbon.

Results and Observations: Concentration of Mg²⁺ was determined in the leaching experiments by EDTA titration with a calcium ion selective electrode. The leachate sample of olivine, which was jet milled and leached overnight at 50° C., had a Mg²⁺ concentration of 0.2491 M.

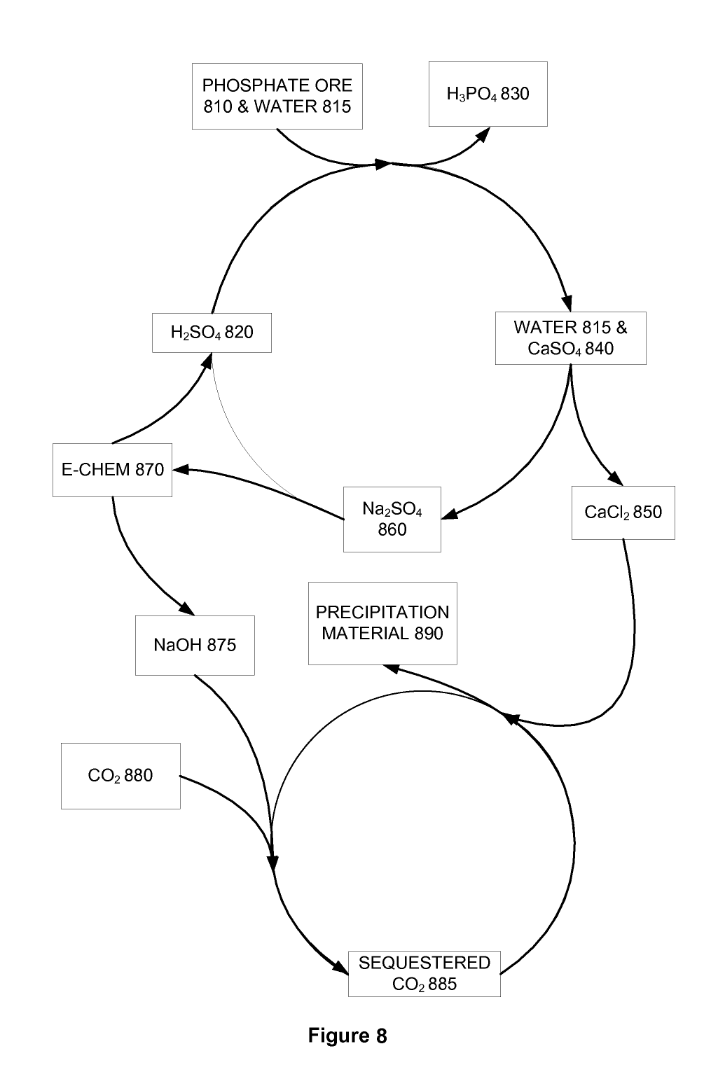

The precipitation material yielded 19.26 g of a coarse, light-grey powder with a tint of yellow-green, which indicated the presence of an iron salt. The precipitation material was fairly easy to crush. SEM (FIG. 8) revealed a mixture primarily composed of thin crystalline rods and amorphous silica gel. EDS measurements indicated the presence of Mg, Si, Fe, Na, and Cl.

XRD (FIG. 9) indicated that the crystalline phases present in the precipitation material were nesquehonite (MgCO₃.3H₂O) and halite (NaCl). Amorphous content was also present, suggesting that there were phases in addition to nesquehonite and halite, which is consistent with the presence of other elements in the EDS analysis.

Carbon coulometry indicated that the product was 4.65% (±0.06) inorganic carbon, which is calculated to be 17.0% CO₂. Thermogravimetric analysis (TGA,) determined a 17.1% weight loss between 275° C. and 575° C., which was previously determined to be the range in which CO₂ is evolved from nesquehonite. Given the XRD identification, and that the TGA and coulometry results were in agreement with each other (<1% difference), it was calculated that the product was composed of 76.6% nesquehonite.

The precipitation material also contained a silicon-based material, which appeared to be amorphous silica (SiO₂), a thermal decomposition product of silicic acid (H₄SiO₄).

TABLE 3
XRF data for precipitation material.

| Na₂O % | MgO % | Al₂O₃ % |
|---|---|---|
| 9.69 | 23.87 | 0.57 |
| SiO₂ % | P₂O₅ ppm | SO₃ % |
| 11.7 | 249 | 0.04 |
| Cl % | K₂O % | CaO % |
| 6.93 | 0.09 | 0.04 |
| TiO₂ % | MnO % | Fe₂O₃ % |
| 0 | 0.043 | 3.1900 |
| Zn ppm | As ppm | Br % |
| 18 | | 0.001 |
| Rb ppm | Sr ppm | Y ppm |
| 0 | 2 | 0 |
| Zr ppm | Nb ppm | Ba ppm |
| 0 | 0 | 0 |
| | | <0.6% by weight |
| Hg ppm | Pb ppm | Alkali Equivalent % |
| | 57 | 9.749 |

% LOI used

| Temp | % LOI | CO3 % diff. |
|---|---|---|
| 950 | 43.79% | 0.005 |

### Example 5

### Neutralization of Hcl and Sequestration of 1 Ton of CO₂

A 10 wt % HCl solution may be neutralized by a ultramafic acid neutralizing material to pH 2, and complete neutralization to a pH of 7 may be accomplished by adding 2.3 ml of 15 wt % NaOH solution, or 0.2% of the volume of the HCl solution that was neutralized. About 7500 liters of 10% HCl solution may be produced from an electrochemical reaction that also be produces in the generation of sufficient NaOH solution to convert 1 tonne of CO₂ to bicarbonate (HCO₃). This mass of HCl (830 kg) may be neutralized to pH 2 by a mass of ultramafic acid neutralizing material of about 1600 kg. Further neutralization to completion (pH 7) may be carried out by adding 2 liters of 10 wt % NaOH solution to the 7500 liters of partially-neutralized solution. The mass of rock needed to neutralize the acid is about 2 times the mass of acid.

### Example 6

### Neutralization of a Sulfuric Acid Solution with Phosphate Ore

An example of the neutralization of an acid from an electrochemical reaction in a manner that advantageously generates a valuable product (phosphoric acid) is shown in FIG. 8. The method shown also provides for the beneficial recycling of sulfate to be used in the electrochemical process. A sample of phosphate ore 810 is reacted with sulfuric acid 820 and water 815 or halite containing brine to form phosphoric acid 830 and calcium sulfate 840. The phosphate ore may contain apatite, phosphorite or any phosphorus containing compound. The phosphate ore may contain sodium or chloride compounds. Sodium and chloride may be provided by a brine. The concentration of sulfuric acid may be greater than 5, or 10 or 15 wt %. The pH of the sulfuric acid may be raised by 1 or 2 or more pH units during the reaction process. The reactants are at least partially converted to phosphoric acid 830 and calcium sulfate (CaSO₄) 840 in the form of phosphogypsum (CaSO₄.2H₂O) during the reaction process according to Eq. IIX below.

Ca₅(PO₄)₃X+5H₂SO₄+2H₂O→3H₃PO₄+5CaSO₄.2H₂O+HX (IIX)

where X may include OH, F, Cl, or Br

The phosphoric acid 830 may be recovered via any method known in the art such as solvent extraction when the phosphoric acid is in an aqueous solution, or precipitation of bi-products (phosphogypsum), or the like. The calcium sulfate 840 and remaining halite containing water 815 and may be processed and separated to yield calcium chloride 850 and sodium sulfate 860. The sodium sulfate is utilized as a feedstock for an electrochemical process 870 to generate sulfuric acid 820 and sodium hydroxide 875. In some embodiments the system contains a phosphate ore processing station operably connected to a sodium sulfate purification station that is operably connected to an electrochemical system. The electrochemical system 870 may be configured to produce no chlorine gas. The electrochemical system may generate sodium hydroxide 875. The sodium hydroxide is utilized in a carbon sequestration process that converts carbon dioxide 880 found in a waste gas into a solution or slurry of sequestered carbon dioxide 885 that contains aqueous carbon dioxide, bicarbonate, carbonic acid, carbonate or any combination thereof. In some embodiments the system and methods of this invention may include combining a portion of the calcium chloride 850 generated from the phosphate ore processing with a portion of the sequestered carbon dioxide 885 to produce a precipitation material 890 for example a building material such as a cement or an aggregate. The precipitation material comprises CaCO₃ and may comprise calcite, aragonite, vaterite, ikaite, amorphous calcium carbonate, monohydrocalcite, or combinations thereof. In some embodiments the precipitation material may be greater that 50% vaterite. In some embodiments, the method further comprises processing the precipitation material to produce a construction material. In such embodiments, the construction material is an aggregate, cement, cementitious material, supplementary cementitious material, or a pozzolan. In some embodiments the methods and systems of this invention provide the generation phosphoric acid by utilizing an acid such as hydrochloric acid or sulfuric acid to convert phosphate ore into phosphoric acid and phosphogypsum CaSO₄.2H₂O (i.e. or calcium chloride), wherein the hydrochloric or sulfuric acid may be generated from an electrochemical process. The hydrochloric or sulfuric acid may be regenerated by extracting a salt such as sodium chloride or sodium sulfate from the products of the phosphoric acid generation reaction and processing the salt in an electrochemical reaction. The electrochemical reaction may generate an acid to recycle into the phosphoric acid production reaction and an alkaline solution for use in a carbon dioxide sequestration reaction. The carbon dioxide may be sequestered as an aqueous solution or slurry of carbonate, bicarbonate, carbonic acid, dissolved carbon dioxide or any combination thereof. In some embodiments the sequestered carbon dioxide may be contacted with calcium recovered from the phosphoric acid generation reaction to form a precipitation material such as a building material.

Analysis Methods

Coulometry: Liquid and solid carbon containing samples were acidified with 2.0 N perchloric acid (HClO4) to evolve carbon dioxide gas into a carrier gas stream, and subsequently scrubbed with 3% w/v silver nitrate at pH 3.0 to remove any evolved sulfur gasses prior to analysis by an inorganic carbon coulometer (UIC Inc, model CM5015). Samples of cement, fly ash, and seawater are heated after addition of perchloric acid with a heated block to aid digestion of the sample.

Brunauer-Emmett-Teller (“BET”) Specific Surface Area: Specific surface area (SSA) measurement was by surface absorption with dinitrogen (BET method). SSA of dry samples was measured with a Micromeritics Tristar™ II 3020 Specific Surface Area and Porosity Analyzer after preparing the sample with a Flowprep™ 060 sample degas system. Briefly, sample preparation involved degassing approximately 1.0 g of dry sample at an elevated temperature while exposed to a stream of dinitrogen gas to remove residual water vapor and other adsorbents from the sample surfaces. The purge gas in the sample holder was subsequently evacuated and the sample cooled before being exposed to dinitrogen gas at a series of increasing pressures (related to adsorption film thickness). After the surface was blanketed, the dinitrogen was released from the surface of the particles by systematic reduction of the pressure in the sample holder. The desorbed gas was measured and translated to a total surface area measurement.

Particle Size Analysis (“PSA”): Particle size analysis and distribution were measured using static light scattering. Dry particles were suspended in isopropyl alcohol and analyzed using a Horiba Particle Size Distribution Analyzer (Model LA-950V2) in dual wavelength/laser configuration. Mie scattering theory was used to calculate the population of particles as a function of size fraction, from 0.1 mm to 1000 mm.

Powder X-ray Diffraction (“XRD”): Powder X-ray diffraction was undertaken with a Rigaku Miniflex™ (Rigaku) to identify crystalline phases and estimate mass fraction of different identifiable sample phases. Dry, solid samples were hand-ground to a fine powder and loaded on sample holders. The X-ray source was a copper anode (Cu kα), powered at 30 kV and 15 mA. The X-ray scan was run over 5-90° 2θ, at a scan rate of 2° 2θ per min, and a step size of 0.01° 2θ per step. The X-ray diffraction profile was analyzed by Rietveld refinement using the X-ray diffraction pattern analysis software Jade™ (version 9, Materials Data Inc. (MDI)).

Fourier Transform Infrared (“FT-IR”) spectroscopy: FT-IR analyses were performed on a Nicolet 380 equipped with the Smart Diffuse Reflectance module. All samples were weighed to 3.5±0.5 mg and hand ground with 0.5 g KBr and subsequently pressed and leveled before being inserted into the FTIR for a 5-minute nitrogen purge. Spectra were recorded in the range 400-4000 cm-1.

Scanning Electron Microscopy (“SEM”): SEM was performed using an Hitachi TM-1000 tungsten filament tabletop microscope using a fixed acceleration voltage of 15 kV at a working pressure of 30-65 Pa, and a single BSE semiconductor detector. Solid samples were fixed to the stage using a carbon-based adhesive; wet samples were vacuum dried to a graphite stage prior to analysis. EDS analysis was performed using an Oxford Instruments SwiftED-TM system, the sensor for which has a detection range of 11Na-92U with an energy resolution of 165 eV.

Soluble Chloride: Chloride concentrations were determined with Chloride QuanTab® Test Strips (Product No. 2751340), having a testing range between 300-6000 mg chloride per liter solution measured in 100-200 ppm increments.

X-ray Fluorescence (“XRF”): XRF analyses of solid powder samples were performed using a Thermo Scientific ARL QUANT'X Energy-Dispersive XRF spectrometer, equipped with a silver anode X-ray source and a Peltier cooled Si(Li) X-ray detector. The samples were pressed into 31 mm pellets using an aluminum sample cup. For each sample, three different spectra were gathered, each tailored for analysis of specific elements: the first using no X-ray filter at 4 kV, the second using a thin silver filter at 18 kV, and the third using a thick silver filter at 30 kV, all under vacuum conditions. Spectra were analyzed using WinTrace software, using a Fundamental Parameters analysis method attained from calibration with certified standard materials.

Thermogravimetric Analysis (“TGA”): TGA analyses of solid powder samples were performed with a TA Instruments SDT Q600 with simultaneous TGA/DSC (Differential Scanning calorimetry). Samples, in an alumina crucible, were placed into a furnace that was heated from room temperature to 1000° C. at a constant ramp rate of 20° C. per minute. The weight loss profile over temperature was analyzed using Universal Analysis software.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any design features developed that perform the same function, regardless of structure. The scope of the present invention, therefore, is not intended to be limited to the exemplary embodiments shown and described herein. Rather, the scope and spirit of present invention is embodied by the appended claims.

1-72. (canceled)

73. A method comprising:
a. an electrochemical reaction to generate a first solution in a first compartment and a second solution in a second compartment of an electrochemical system wherein the first solution is alkaline and the second solution is acidic, wherein the acidic solution has a pH that is less than 1.3;
b. sequestering carbon dioxide from a gas comprising carbon dioxide; wherein the sequestering the carbon dioxide comprises contacting the gas with a first portion of the first solution;
c. digesting an acid neutralizing material with the second solution to produce a digestion product comprising a third solution, wherein the pH of the third solution is higher than pH of the second solution.

74. The method of claim 73 wherein the digestion product comprises calcium.

75. The method of claim 73 wherein the pH of the third solution is at least 0.5 pH points greater than the pH of the second solution.

76. The method of claim 73 wherein the digestion product comprises silicate.

77. The method of claim 73 wherein a portion of the digestion product is contacted with the sequestered carbon dioxide.

78. The method of claim 73 wherein the electrochemical reaction is configured to not produce chlorine gas.

79. A method comprising:
a. generating a first solution and a second solution in an electrochemical reaction;
wherein the first solution is alkaline and the second solution is acidic and wherein the electrochemical reaction is configured to not produce chlorine gas
b. digesting an acid neutralizing material with the second solution to form a slurry comprising a third solution, wherein the pH of the third solution is greater than the second solution by at least 0.5 pH units.

80. The method of claim 79 wherein the electrochemical reaction comprises
i. separating an anode electrolyte in contact with a gas diffusion anode from a cathode electrolyte in contact with a cathode using an ion exchange membrane in an electrochemical system;
ii. applying a voltage across the gas diffusion anode and cathode;
iii. directing hydrogen gas to the gas diffusion anode using hydrogen gas produced at the cathode;
iv. oxidizing hydrogen gas to protons at the anode without producing a gas at the anode;
v. migrating protons from the anode into the anode electrolyte to produce the second solution in the anode electrolyte to avoid the production of a gas.

81. The method of claim 79 further comprising:
c. sequestering carbon dioxide from a gas comprising carbon dioxide; wherein sequestering the carbon dioxide comprises contacting the gas with the first solution.

82. The method of claim 79 wherein the second solution is between 40 and 84° C. when contacting the acid neutralizing material.

83. The method of claim 79 wherein the third solution comprises calcium.

84. The method of claim 79 wherein the second solution comprises an acid selected from hydrochloric acid, sulfuric acid, acetic acid, hydrofluoric acid, boric acid and nitric acid.

85. The method of claim 73 wherein the second solution comprises an acid selected from hydrochloric acid, sulfuric acid, acetic acid, hydrofluoric acid, boric acid and nitric acid.

86. The method of claim 79 wherein the second solution comprises hydrochloric acid.

87. The method of claim 79 wherein the second solution is between 10 and 36 wt % acid.

88. The method of claim 79 wherein the pH of second solution is between −1 and 1.

89. The method of claim 73 wherein the pH of second solution is between −1 and 1.

90. The method of claim 79 wherein the acid neutralizing material comprises less than 1 wt % carbonate.

91. The method of claim 73 wherein the acid neutralizing material comprises an alkaline earth metal silicate or an alkaline earth phorsphorite.

92. The method of claim 91 further comprising contacting the alkaline earth metal with the sequestered carbon dioxide to precipitate a carbonate containing compound.

93. The method claim 79 wherein the acid neutralizing material comprises silicates or phosphorus.

94. The method of claim 93 wherein digesting the acid neutralizing material releases silicates into the third solution.

95. The method of claim 94 further comprising combining the sequestered carbon dioxide and the silicates to produce a building material.

96. The method of claim 73 wherein the acid neutralizing material comprises mafic rock.

97. The method of claim 96 wherein the mafic rock comprises basalt.

98. The method of claim 73 wherein the acid neutralizing material comprises ultramafic rock.

99. The method of claim 73 wherein the acid neutralizing material comprises felsic rock.

100. The method of claim 73 wherein the acid neutralizing material is anorthite and wherein contacting anorthite and the acidic solution forms kaolinite and a divalent cation.

101. The method of claim 100 further comprising converting the kaolinite to metakaolin.

102. The method of claims 73 further comprising contacting the third acidic solution with a second portion of the first solution.

103. The method of claim 102 wherein the contacting with a second portion of the first solution generates a neutralized solution.

104. The method of claim 103 further comprising disposing of the neutralized solution an underground location.

105. The method of claim 104 further comprising utilizing a portion of the neutralized solution in the electrochemical reaction.

106. The reaction of claims 73 wherein the electrochemical reaction proceeds after a voltage of less than 2 volts is applied.

107. The reaction of claim 73 wherein the electrochemical reaction is configured to avoid production of chlorine gas.

108. A system for sequestering carbon dioxide comprising:
a. an electrochemical system suitable for generating an first solution in a first compartment and a second solution in a second compartment, wherein the second compartment is suitable for containing a solution that has a pH that is less than 1.3;
b. a first reaction vessel operably connected to a source of waste gas and the electrochemical system connected to an absorber suitable for contacting a gas comprising carbon dioxide with the first solution to sequester carbon dioxide; and
c. a second reaction vessel operably connected to the electrochemical system and a source of an acid neutralizing material suitable to contact the second solution comprising a pH of less that 1.3 with the acid neutralizing material wherein the contact is sufficient to form a third solution that has a higher pH than the second solution.

109. The system of claim 108 wherein the acid neutralizing material comprises a divalent cation and wherein the third solution comprises divalent cation released from the acid neutralizing material; and
a. further comprising a third reaction vessel operably connected to the first reaction vessel and the second reaction vessel suitable for contacting the third solution to the sequestered carbon dioxide wherein the contact is sufficient to generate a carbonate precipitate.

110. The system according to claim 108 wherein the electrochemical system is configured to prevent the release of chlorine gas.

111. The system according to claim 108 wherein the electrochemical system is configured to the produce the acidic solution composition at a voltage of 2.0 volts or less.

112. The system according to claim 108 wherein reaction vessel is suitable for promoting the release of an alkaline earth metal from the acid neutralizing material into the third solution.
